(19) United States
(12) Patent Application Publication
(10) Pub. No.: US 2001/0042047 A1
(43) Pub. Date: Nov. 15, 2001

(54) Server computer, and card delivery control method

(76) Inventor: Hideharu Nishida, Osaka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/821,727

(22) Filed: Mar. 30, 2001

(30) Foreign Application Priority Data
Mar. 31, 2000 (JP) 2000-96385

(51) Int. Cl. G06F 17/60; G06F 17/30; G06F 15/16

(52) U.S. Cl. 705/51; 707/10; 705/64; 707/3; 709/206; 707/104.1

(57) ABSTRACT

There are described a server computer for delivering cards, such as Birthday cards or Christmas cards, over the Internet and a card delivery control method employing the server computer, wherein a distributor user is reminded of delivery of cards. On a user computer there is displayed a selection input screen which displays data pertaining to cards stored in a storage device. The distributor user selects a card on the selection input screen appearing on his user computer, whereupon a correction input screen is displayed. The distributor user can correct data pertaining to the card on the correction input screen. A delivery schedule notification mail is sent to the distributor user a predetermined period before a scheduled delivery date of the card, for the purpose of ascertaining whether to send the card. Upon receipt of the transmission schedule notification mail, the distributor user can correct details of the card.

### BACKGROUND OF THE INVENTION

1. Field of the Invention

The present invention relates to a server computer for sending an on-line card to a destination in accordance with input operation performed by a user. Further, the present invention relates to a card delivery control method for sending an on-line card through use of the server computer.

2. Description of the Related Art

A card distribution system which distributes greeting cards, such as birthday cards, by utilization of the Internet has hitherto become prevalent. According to the distribution system, the user accesses the home page of a site (i.e., a worldwide web site) at which card distribution is performed. As the user performs an input operation in accordance with an input screen, the user can send to a destination a card corresponding to input data. The home page at which card distribution set forth is effected is provided by a server computer having the capability of offering such a distribution service.

However, distribution of cards by use of a related-art card distribution site in the manner mentioned above involves much effort of operations. For example, in a case where greeting cards, such as birthday cards, are distributed, the user must perform laborious operations, such as selection of a card image, description of a message, entry of names of destinations (receivers), and entry of addresses of the destinations. Particularly, in most cases, greeting cards, such as birthday cards and Christmas cards, are usually distributed repeatedly and annually. Annual repetition of laborious procedures required for distributing cards poses inconvenience to the user. Cards, such as New Year's cards or Christmas cards, are scheduled to be delivered on predetermine dates. A large number of cards must be distributed simultaneously. Repetition of all the procedures set forth for such cards is a considerably laborious task.

In connection with cards to be distributed on personal anniversaries, such as birthday cards or wedding anniversary cards, there may be a case where a card cannot be distributed unless the user who desires to send clearly memorizes the date of the anniversary.

### SUMMARY OF THE INVENTION

Accordingly, the present invention is aimed at providing a card delivery system and a card delivery control method which can eliminate the foregoing drawbacks, enable delivery of cards with a simple operation, and remind a user of delivering cards.

The present invention has been conceived to solve the foregoing drawbacks and provides a server computer which performs an operation for sending cards to destinations in accordance with operation of a user computer, comprising:

a storage device for storing, on a per-card basis, data which are required for sending a card to a predetermined destination, at least a portion of the data being based on data received from the user computer;

a selection input screen data transmission device which sends data pertaining to the selection input screen to the user computer for causing the user computer to display a selection input screen, wherein the selection input screen displays on a per-card basis a predetermined data set of the data stored in the storage device and enables selection of at least one card;

a correction input screen data transmission device which transmits data pertaining to a correction input screen to the user computer in order to cause the user computer to display the correction input screen, the correction input screen being a single or a plurality of input screens for enabling, on the user computer, at least one of a data correction operation for correcting data pertaining to cards selected on the selection input screen and a data addition operation for effecting addition of data pertaining to the selected card; and

a stored data change device which makes at least changes or additions to the data which pertain to a selected card and are stored in the storage device, on the basis of data received from the user computer in accordance with an input operation performed on the correction input screen.

In the server computer according to the present invention, the selection input screen data transmission device displays predetermined data from among the data stored in the storage device for each card. In order to cause the user computer to display a selection input screen which is an input screen for enabling selection of at least one card, data pertaining to the selection input screen are transmitted to the user computer. Hence, the selection input screen appears on the user computer.

When the distributor user selects a card on the selection input screen appearing on the user computer, the correction input screen data transmission device sends to the user computer data pertaining to a correction input screen, in order to cause the user computer to display the correction input screen. The correction input screen is one or a plurality of input screens for enabling on the user computer at least either a data correction operation for correcting data pertaining to a selected card, or a data addition operation for effecting addition of data pertaining to the selected card.

When the distributor user performs a data correction operation or a data addition operation on the correction input screen appearing on the user computer, the stored data change device changes the data stored in the storage device by at least either correcting data pertaining to the selected card stored in the storage device on the basis of the data received from the user computer in accordance with an input operation performed on the correction input screen, or effecting addition of data pertaining to the selected card.

The server computer enables changes to be made to memory contents of each card by means of changing necessary data without a necessity for entering all data sets required for sending a card. In other words, the server computer enables changes to the contents of each card through a very simple operation. Even when the contents or destination of a card are desired to be changed, the distributor user is required to enter only changes. The card can be used the next time with only necessary changes.

Preferably, there can be performed, on the correction input screen, a card addition operation for enabling addition of data pertaining to a new card, through use of data pertaining to a card selected on the selection input screen, and the stored data change device adds data pertaining to a new card to the data stored in the storage device when the card addition operation has been performed on the correction input screen. In this case, data pertaining to a new card based on the data pertaining to an existing card are added to the data stored in the storage device. Hence, application of a new card can be effected through a very simple operation.

Preferably, when a plurality of cards are selected on the selection input screen and when there is performed, on the correction input screen, at least one of an operation for correcting data pertaining to the selected plurality of cards and an operation for effecting addition of data pertaining to the selected cards, the stored data change device rewrites the data pertaining to the plurality of cards in accordance with data received as a result of an input operation on the correction input screen, by means of a single operation. In this case, contents of a plurality of cards can be changed by means of a single operation. Hence, a plurality of cards can be changed by means of a simple operation.

Preferably, the server computer further comprises a card delivery device for performing procedures for sending a card to a destination on a predetermined delivery date; and wherein the card delivery device has a plurality of modes which are selectable in a card delivery mode by a distribution user; at least one of a plurality of modes is a principal mode for sending, to a user computer of a destination user, data for specifying a site for browsing a card and data which are required for browsing a card and are uniquely provided to the destination user; and at least one of the other modes is a mail mode for sending at least a message in the form of an electronic mail, or a printout mode for printing a card and sending the printed card to a destination user. Moreover, at least one of the other modes is preferably a mail mode for sending at least a message in the form of an electronic mail, or a printout mode for printing a card and sending the printed card to a destination user.

In this case, the distributor user can select one from a plurality of modes and send a card to a destination user in a desired mode.

Preferably, at least one of the application input screen and the correction input screen enables selection of one from a delivery-determined mode for sending a card on a predetermined delivery date, and a delivery-pending mode for holding delivery of a card even when a predetermined delivery date has come, and data pertaining to either the delivery-determined mode or the delivery-pending mode are stored for each card in the storage device.

In this case, delivery of a desired card on a predetermined delivery date can be held.

Preferably, an indication stating that either the delivery-determined mode or the delivery-pending mode is assigned to a card is displayed for each card on the selection input screen.

In this case, the distributor user can ascertain, for each card, whether the card is in a delivery-determined mode or a delivery-pending mode.

Preferably, the selection input screen data transmission apparatus transmits data in response to an access from the user computer.

Preferably, at least either the application input screen or the correction input screen enables an operation of selectively entering a predetermined card image from a plurality of card images, an operation for entering a message, and an operation for entering destination specification data including at least the E-mail (or postal) address of a destination; and

the storage device stores, for each card, data pertaining to a selected card image, data pertaining to an entered message, and entered destination specification data.

The present invention also provides a server computer which performs an operation for sending cards to destinations in accordance with operation of a user computer, comprising:

a storage device for storing, on a per-card basis, data which are required for sending a card to a predetermined destination, at least a portion of the data being based on data received from the user computer; and

a query device which sends, to the user computer, a message querying whether to perform an operation for sending a card on a predetermined delivery date, with regard to a predetermined card of cards stored in the storage device.

The server computer according to the present invention ascertains whether to send a card on a delivery date, thus giving a distributor user many chances to determine whether to send a card. A query is made in relation to cards which have been sent in the past and are stored in the storage device. A card can be utilized the next time through a simple operation with changes being made to required data. As a result of such a query being made in relation to the cards stored in the storage device, the distributor user can ascertain that an event of a destination user, such as a birthday, is approaching. Thus, the distributor user is reminded of delivery of a card.

Preferably, the server computer further a correction input screen data transmission device which transmits data pertaining to a correction input screen to the user computer in order to cause the user computer to display the correction input screen, the correction input screen being one or a plurality of input screens for effecting, on the user computer, at least one operation of a data correction operation for correcting data pertaining to cards for which queries have been made by the query device, and a data addition operation for effecting addition of data pertaining to the cards; and

a stored data change device which makes changes or additions to the data which pertain to a selected card and are stored in the storage device, on the basis of data received from the user computer in accordance with an input operation performed on the correction input screen.

In this case, memory contents of each card can be changed by means of changing only required data without a necessity for entering all data sets required for sending a card. In other words, the server computer enables changes to the contents of each card through a very simple operation. Even when the contents or destination of a card are desired to be changed, the distributor user is required to enter only changes. The card can be used the next time with only necessary changes.

Preferably, there can be performed, on the correction input screen, a card addition operation for enabling addition of data pertaining to a new card, through use of data pertaining to the cards for which queries have been made by the query device, and the stored data change device adds data pertaining to a new card to the data stored in the storage device when the card addition operation has been performed on the correction input screen.

In this case, data pertaining to a new card based on the data pertaining to an existing card are added to the data stored in the storage device. Hence, application of a new card can be effected through a very simple operation.

Preferably, when a plurality of cards of the same type are objects of query, the query device makes a query concerning the plurality of cards by means of a single operation; and wherein the server computer further comprises a selection input screen data transmission device which transmits to the user computer data pertaining to a selection input screen, in order to cause the user computer to display the selection input screen for enabling selection of at least one card from the plurality of cards which are objects of query, wherein on the correction input screen there can be performed at least either a data correction operation for correcting data pertaining to cards selected on the selection input screen, or a data addition operation for effecting addition of data pertaining to the selected card.

In this case, queries are to be made in relation to a plurality of cards at one time. Hence, the distributor user can be freed from inconvenience stemming from an unnecessary increase in the number of queries. Memory contents of respective cards can be changed through a very simple operation.

Preferably, when a plurality of cards are selected on the selection input screen and when there is performed, on the correction input screen, at least either an operation for correcting data pertaining to the selected plurality of cards or an operation for effecting addition of data pertaining to the selected cards, the stored data change device rewrites the data pertaining to the plurality of cards in accordance with data received from the user computer as a result of an input operation on the correction input screen, by means of a single operation. In this case, contents of a plurality of cards can be changed by means of a single operation. Hence, a plurality of cards can be changed by means of a simple operation.

Further, the present invention provides a card delivery control method in which a server computer is used for performing an operation for sending cards to destinations in accordance with operation of a user computer, comprising:

a selection input screen data transmission step which sends data pertaining to the selection input screen to the user computer for causing the user computer to display a selection input screen, wherein the selection input screen displays on a per-card basis a predetermined data belonging to the data stored in a storage device and enables selection of at least one card, wherein the storage device stores, on a per-card basis, data required for sending a card to a predetermined destination, a portion of the data being based on data received from a user computer;

a correction input screen data transmission step of transmitting to the user computer data pertaining to a correction input screen in order to cause the user computer to display the correction input screen, the correction input screen being a single or a plurality of input screens for enabling, on the user computer, at least either a data correction operation for correcting data pertaining to cards selected on the selection input screen or a data addition operation for effecting addition of data pertaining to the selected card; and

a stored data change step which makes at least changes or additions to the data which pertain to a selected card and are stored in the storage device, on the basis of data received from the user computer in accordance with an input operation performed on the correction input screen.

The server computer enables changes to memory contents of each card by means of changing necessary data without a necessity for entering all data sets required for sending a card. In other words, the server computer enables changes to the contents of each card through a very simple operation. Even when contents or destination of a card are desired to be changed, the distributor user is required to enter only changes. The card can be used the next time with only necessary changes.

Preferably, there can be performed, on the correction input screen, a card addition operation for enabling addition of data pertaining to a new card through use of data pertaining to a card selected on the selection input screen, and the stored data change step involves addition of data pertaining to a new card to the data stored in the storage device when the card addition operation has been performed on the correction input screen. In this case, data pertaining to a new card based on the data pertaining to an existing card are added to the data stored in the storage device. Hence, application of a new card can be effected through a very simple operation.

Preferably, when a plurality of cards are selected on the selection input screen and when there is performed, on the correction input screen, at least either an operation for correcting data pertaining to the selected plurality of cards or an operation for effecting addition of data pertaining to the selected cards, the stored data change step involves rewriting of the data pertaining to the plurality of cards in accordance with data received as a result of an input operation on the correction input screen, by means of a single operation. In this case, contents of a plurality of cards can be changed by means of a single operation. Hence, a plurality of cards can be changed by means of a simple operation.

Preferably, the card delivery control method further comprises a card delivery step of executing procedures for sending a card to a destination on a predetermined delivery date; the card delivery step is provided with a plurality of modes which can be selected in a card delivery mode by a distributor user; at least one of the plurality of modes is a principal mode for sending, to a user computer of a destination user, data for specifying a site for browsing a card and data which are required for browsing the card and uniquely provided to the destination user; and at least one of the other modes is a mail mode for sending to a destination user at least a message in the form of an electronic mail, or a printout mode for printing a card and sending the printed card to the destination user.

Hence, the distributor user can select one from a plurality of modes and send a card to a destination user in a desired mode.

Preferably, at least either the application input screen or the correction input screen enables selection of one from a delivery-determined mode for sending a card on a predetermined delivery date, and a delivery-pending mode for holding delivery of a card even when a predetermined delivery date has come, and data pertaining to either the delivery-determined mode or the delivery-pending mode are stored for each card in the storage device.

In this case, delivery of a desired card on a predetermined delivery date can be held.

Preferably, an indication stating that either the delivery-determined mode or the delivery-pending mode is assigned to a card is displayed for each card on the selection input screen. In this case, the distributor user can ascertain, for each card, whether the card is in a delivery-determined mode or a delivery-pending mode.

Preferably, the selection input screen data transmission apparatus transmits data in response to an access from the user computer.

Preferably, at least either the application input screen or the correction input screen enables an operation of selectively entering a predetermined card image from a plurality of card images, an operation for entering a message, and an operation for entering destination specification data including at least the E-mail (or postal) address of a destination; and

the storage device stores, for each card, data pertaining to a selected card image, data pertaining to an entered message, and entered destination specification data.

The present invention also provides a card delivery control method in which a server computer is used for performing an operation for sending cards to destinations in accordance with operation of a user computer, comprising:

a query step of sending, to the user computer, a message querying whether to perform an operation for sending a card on a predetermined delivery date, with regard to a predetermined card of cards stored in a storage device which stores on a per-card basis data required for sending a card to a predetermined destination, at least a portion of the data being based on data received from the user computer.

Under this method, it is ascertained whether a card is to be sent on a delivery date, thus giving a distributor user many chances to determine whether to send a card. A query is made in relation to cards which have been sent in the past and are stored in the storage device. A card can be utilized the next time through a simple operation with changes being made to required data. As a result of such a query being made in relation to the cards stored in the storage device, the distributor user can ascertain that an event of a destination user, such as a birthday, is approaching. Thus, the distributor user is reminded of delivery of a card.

The above invention may also be embodied as follows: A card delivery control method in which a server computer is used for performing an operation for sending cards to destinations in accordance with operation of a user computer, comprising:

a determination step which makes a determination as to whether or not it is necessary to send, to the user computer, a message querying whether to perform an operation for sending a card on a predetermined delivery date, with regard to a predetermined card of cards stored in a storage device which stores on a per-card basis data required for sending a card to a predetermined destination, at least a portion of the data being based on data received from the user computer; and

a query step of sending, to the user computer, the message in the case that the determination in the determination step is that it is necessary to send the message.

Preferably, the card delivery control method further comprises:

a correction input screen data transmission step of transmitting to the user computer data pertaining to a correction input screen in order to cause the user computer to display the correction input screen, the correction input screen being one or a plurality of input screens for effecting, on the user computer, at least either a data correction operation for correcting data pertaining to cards for which queries have been made by the query device, or a data addition operation for effecting addition of data pertaining to the cards; and

a stored data change step of making at least changes or additions to the data which pertain to a selected card and are stored in the storage device, on the basis of data received from the user computer in accordance with an input operation performed on the correction input screen.

In this case, memory contents of each card can be changed by means of changing only required data without a necessity for entering all data sets required for sending a card. In other words, the server computer enables changes to the contents of each card through a very simple operation. Even when contents or destination of a card are desired to be changed, the distributor user is required to enter only changes. The card can be used the next time with only necessary changes.

Preferably, there can be performed, on the correction input screen, a card addition operation for enabling addition of data pertaining to a new card through use of data pertaining to the cards for which queries have been made in the query step, and the stored data change step effects addition of data pertaining to a new card to the data stored in the storage device when the card addition operation has been performed on the correction input screen.

In this case, data pertaining to a new card based on the data pertaining to an existing card are added to the data stored in the storage device. Hence, application of a new card can be effected through a very simple operation.

Preferably, when a plurality of cards of the same type are objects of query, in the query step a query about the plurality of cards is made by means of a single operation; and wherein the card delivery control method further comprises a selection input screen data transmission step of transmitting to the user computer data pertaining to a selection input screen, in order to cause the user computer to display the selection input screen for enabling selection of at least one card from the plurality of cards which are objects of query, wherein on the correction input screen there can be performed at least either a data correction operation for correcting data pertaining to cards selected on the selection input screen, or a data addition operation for effecting addition of data pertaining to the selected card.

In this case, queries in relation to a plurality of cards are made at one time. Hence, the distributor user can be freed from inconvenience stemming from an unnecessary increase in the number of queries. Memory contents of respective cards can be changed through a very simple operation.

Preferably, when a plurality of cards are selected on the selection input screen and when there is performed, on the correction input screen, either an operation for correcting data pertaining to the selected plurality of cards or an operation for effecting addition of data pertaining to the selected cards, the stored data change step effects rewriting of the data pertaining to the plurality of cards in accordance with data received from the user computer as a result of an input operation on the correction input screen, by means of a single operation.

In this case, the distributor user can select one from a plurality of modes and send a card in a desired mode.

### BRIEF DESCRIPTION OF THE DRAWINGS

FIG. 1 is a block diagram showing a server computer according to the present invention and an overall card transmission system including the server computer;

FIG. 2 is a block diagram showing the server computer according to the present invention;

FIG. 3 is a descriptive view showing the configuration of a management table;

FIG. 4 is a flowchart for describing the operation of a server computer;

FIG. 5 is a flowchart for describing the operation of the server computer;

FIG. 6 is a flowchart for describing the operation of the server computer;

FIG. 7 is a flowchart for describing the operation of the server computer;

FIG. 8 is a flowchart for describing the operation of the server computer;

FIG. 9 is a flowchart for describing the operation of the server computer;

FIG. 10 is a flowchart for describing the operation of the server computer;

FIG. 11 is a flowchart for describing the operation of the server computer;

FIG. 12 is a descriptive view showing an initial screen;

FIG. 13 is a descriptive view showing a card type selection screen;

FIG. 14 is a descriptive view showing an individual card selection screen;

FIG. 15 is a descriptive view showing a message input screen;

FIG. 16 is a descriptive view showing a destination input screen;

FIG. 17 is a descriptive view showing a delivery instruction screen;

FIG. 18 is a descriptive view showing a destination addition instruction screen;

FIG. 19 is a descriptive view showing a history display screen;

FIG. 20 is a descriptive view showing a change instruction screen;

FIG. 21 is a descriptive view showing contents of a delivery schedule notification mail;

FIG. 22 is a descriptive view showing a simplified delivery instruction screen;

FIG. 23 is a descriptive view showing contents of a delivery schedule notification mail; and

FIG. 24 is a descriptive view showing a simplified delivery instruction screen.

### DETAILED DESCRIPTION OF THE PREFERRED EMBODIMENTS

Preferred embodiments of the present invention will be described hereinbelow by reference to accompanying drawings. A server computer 1 according to the present invention act as a card distribution apparatus (may also be referred to as a “card distribution system”). The server computer 1 is connected to user computers 2 through 5 by way of the Internet 6. More specifically, the server computer 1 is connected to the user computers 2 through 5 by way of a telecommunications line, such as a telephone line. The server computer 1 and the user computers 2 through 5 can communicate with each other over the Internet.

Data are exchanged between the server computer 1 and the user computers 2 through 5 over the Internet 6. For instance, the server computer 1 sends to the user computers 2 through 5 data pertaining to an input screen required for delivering cards or data pertaining to mail information, such as “delivery schedule notification mail” to be described later, and data to a prepared card. Further, the data entered in accordance with the input screen are transmitted from the user computers 2 through 5 to the server computer 1.

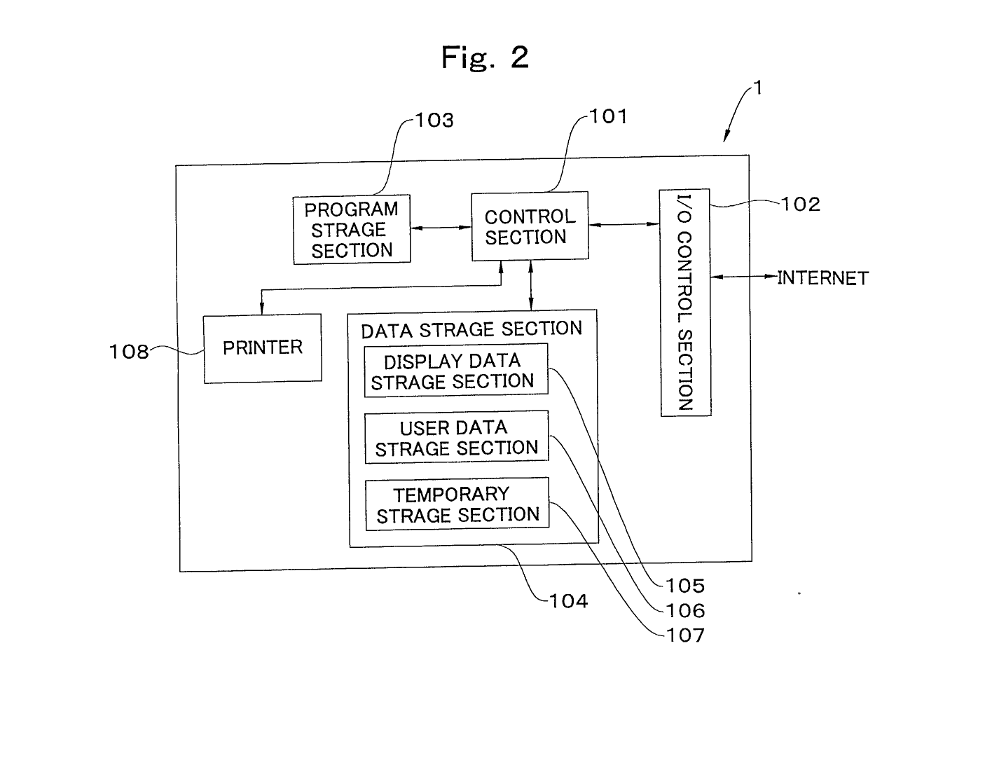

Here, the configuration of the server computer 1 will be described. As shown in FIG. 2, the server computer 1 comprises a control section 101, an I/O control section 102, a program storage section 103, a data storage section 104, and a printer 108.

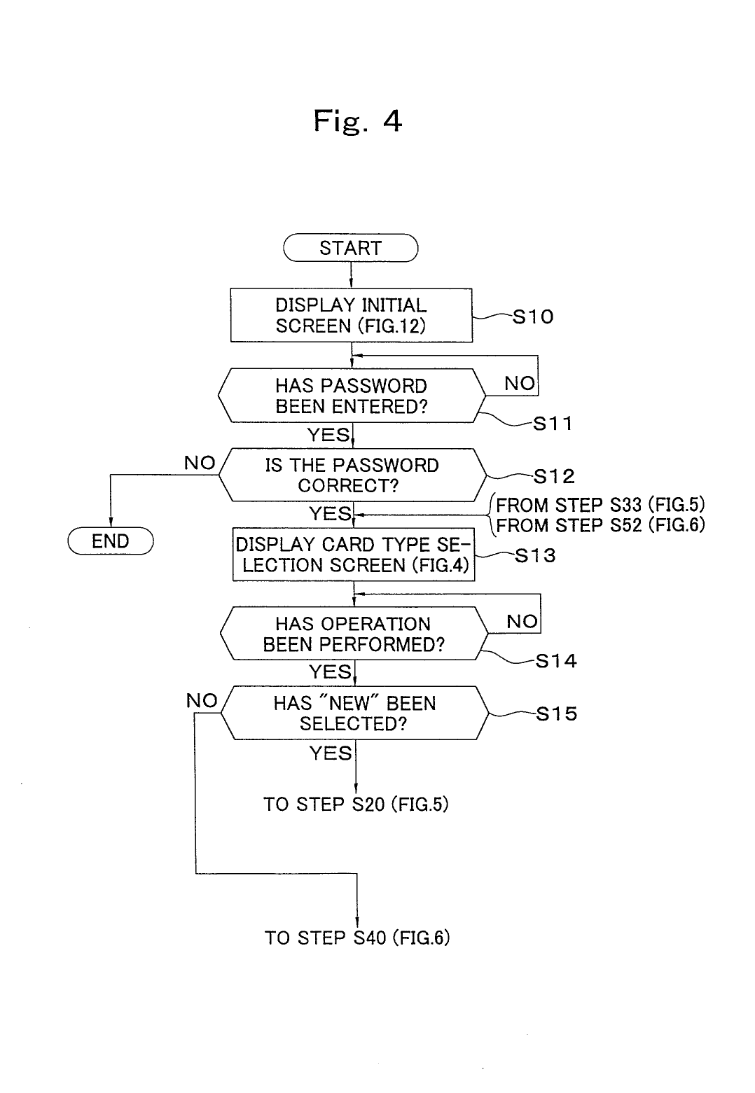

The control section 101 is made up of a CPU and performs processing pertaining to control of individual sections of the server computer 1, data transfer, computation, and temporary storage of data. More specifically, the control section 101 operates in accordance with the program stored in the program storage section 103 and performs processing in accordance with flowcharts shown in FIGS. 4 through 11. As shown in FIG. 2, the control section 101 is connected to the I/O control section 102, the program storage section 103, and the data storage section 104.

The I/O control section 102 controls input and output of data from and to the Internet. The I/O control section 102 is embodied by a communications device capable of establishing communication with the outside over the Internet. More specifically, the I/O control section 102 acts as an interface with the outside.

The program storage section 103 is a memory section for storing various types of programs to be used for activating the server computer 1. The program storage section 103 principally stores a control program for controlling the control section 101. More specifically, the program storage section 103 principally stores a program for causing the server computer 1 to perform processing described in the flowcharts shown in FIGS. 4 through 11. For instance, the program storage section 103 preserves a program for causing a user computer to display a predetermined screen; a program for detecting the data that have been received in accordance with the data entered by way of a user computer; a program for managing a management table K (which will be described later), such as writing of data into the management table K or changes in the data stored in the management table K; and a program for sending an electronic mail to a user computer. The program storage section 103 is constructed by means of storing programs into storage devices.

The data storage section 104 is a memory section for preserving various types of data sets. As shown in FIG. 2, the data storage section 104 comprises a display data storage section 105, a user data storage section 106, and a temporary storage section 107. More specifically, the data storage section 104 is constructed of a storage device.

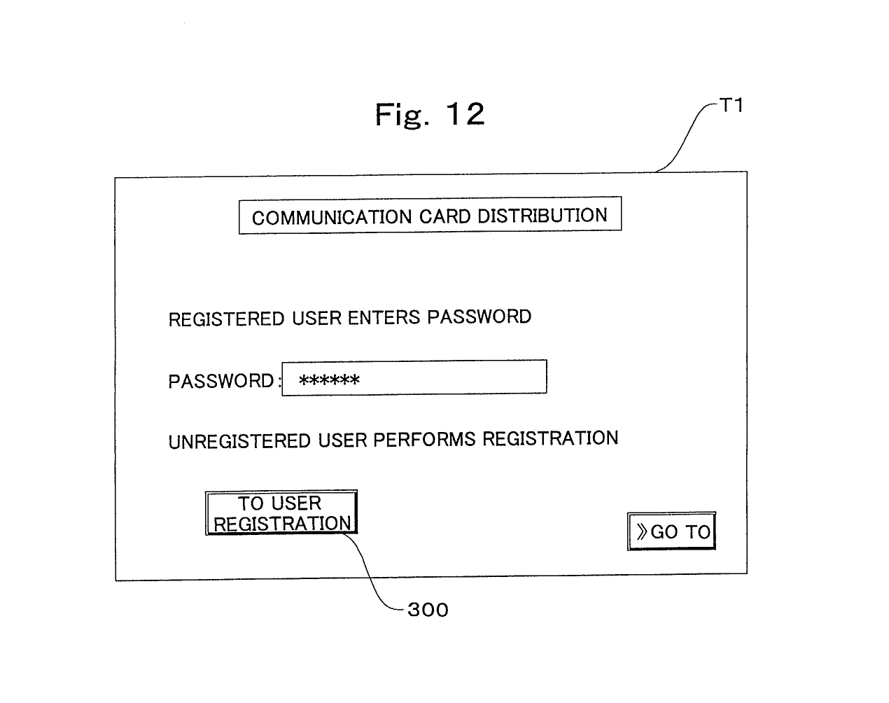

The display data storage section 105 stores display data to be displayed on the user computers 2 through 5. More specifically, the display data storage section 105 stores screen data pertaining to screens shown in FIGS. 12 through 24 and card data pertaining to cards, such as birthday cards, wedding cards, New Year's cards, Christmas cards, and Valentine cards. Here, the wedding cards include both a wedding ceremony card and a wedding anniversary card.

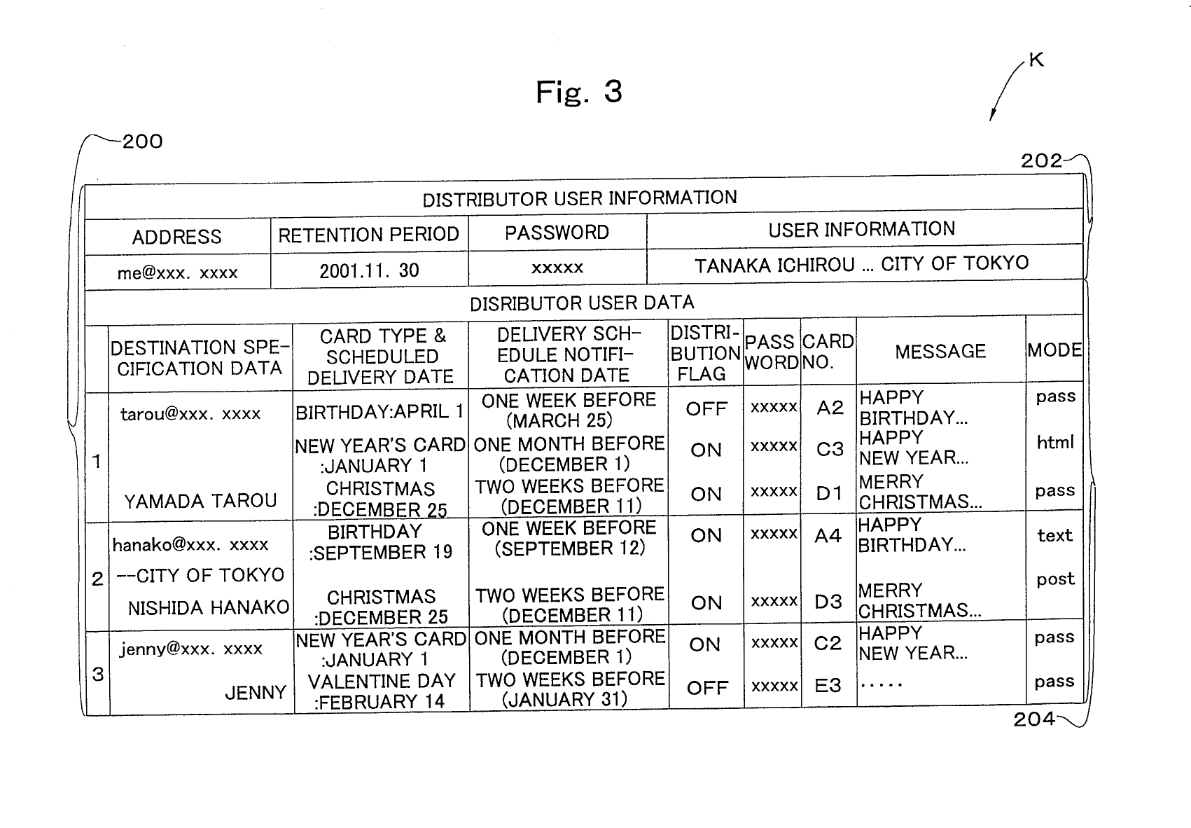

The user data storage section 106 stores user information concerning a distributor user who has sent cards (also called a “contract user” or “sender user”), and data pertaining to users who are to receive cards (also called “destination users”). Particularly, the management table K, such as that shown in FIG. 3, is stored in the user data storage section 106.

The management table K is constructed in the manner as shown in FIG. 3, and management information 200 is stored for each contract user. The management information 200 is constituted of distributor user information 202 and destination user information 204. More specifically, data pertaining to a user who sends a card and data pertaining to a user who receives the card sent by the distributor user are stored as a pair.

As the distributor user information 202; that is, data pertaining to a distributor user, there are managed information about a contract user; that is, an “address,” a “retention period,” a “password,” and “user information.” In connection with an “address,” the E-mail address of the contract user; that is, the E-mail address of the distributor user, is stored. In connection with a “retention period,” there is stored information about a date by which a certain period of time (e.g., one year) will have elapsed from the date at which sending of the last card was specified. The control section 101 counts a period of time which has lapsed from the sending date of the last card. When a certain period of time has elapsed, management information about a distributor user; that is, data pertaining to a distributor user, and data pertaining to destination user which pair up with the data pertaining to the distributor user, are deleted from the management table K. Here, a “password” is assigned to a user when the user has effected registration. For example, information about a password set by a distributor user when the distributor user sends a first card is stored as a “password.” Further, information such as the name and address of a contact user are stored as “user information.” In addition, the “number of times a card is to be sent” may be stored as the distributor user information. In connection with the “number of times,” every time a card is sent the control section 101 increments the number of times a card is sent so as to count the number. Information about the counted number of times is stored as the “number of times.”

The destination user information 204 is stored for each destination user who is to receive a card. Information pieces; e.g., “destination specification data,” a “card type & specified delivery date,” a “delivery schedule notification date,” a “distribution flag,” a “password,” a “card number,” a “message,” and a “mode,” are stored as the destination user information 204.

Here, the “destination specification data” is information to be used for specifying the E-mail and postal addresses of a user who is to receive a message. Information about an event according to the type of a card, such as a Birthday card, a New Year's card, or a Christmas card, and information about a specified delivery date of the card are to be stored in the field “Card type & scheduled delivery date.” The specified date at which a card is to be sent is specified by a distributor user or automatically set by the control section 101. In other words, the specified delivery date is a date at which delivery of a card is to be effected. For example, with regard to a card to be sent on a personal anniversary, such as a birthday or a date of a wedding ceremony (or a wedding anniversary), a delivery date of the card is set by the distributor user through input operation. In contrast, with regard to cards whose delivery dates are specified beforehand, such as New Year's card, Christmas cards and Valentine cards, the control section 101 automatically sets a delivery date of each card in accordance with a program stored in the program storage section 103.

In the field “delivery schedule notification date,” there is stored a date which is determined by subtracting a certain period of time from a specified delivery date. For instance, in the case of a birthday and a date of a wedding ceremony (or a wedding anniversary), a delivery schedule notification date is determined by subtracting one week from the birthday or the date of the wedding ceremony (or a wedding anniversary). In the case of a New Year's card, a delivery schedule notification date is determined by subtracting one month from January 1^{st}. Further, in the case of a New Year's card, a Christmas card, or a Valentine card, a delivery schedule notification date is determined by subtracting two weeks from Christmas day or Valentine's Day. When a delivery schedule notification date arrives, the control section 101 prepares a predetermined electronic mail and sends the mail to the distributor user. With regard to a card which has not yet been determined to be sent, the control section 101 sends a “delivery schedule notification” mail (also called as “confirmation mail”) as to whether or not the scheduled card is to be sent. With regard to the card which has already been sent, the control section 101 sends a “delivery schedule notification” mail (also called a “information mail”) as to whether or not a card is to be sent in the same manner as mail that has been sent in the past. The confirmation mail and the notification mail will be further described in detail later. In connection with a card whose delivery date is specified, such as a New Year's card or a Christmas card, a “delivery schedule notification mail” is sent simultaneously to a plurality of destination users. “Delivery schedule notification mails” regarding a plurality of destination users are simultaneously delivered to the distributor user. Simultaneous delivery of the notification mails will also be described in detail later.

The “distribution flag” is a flag showing whether or not transmission of a card has already been completed. If transmission of a card has already been completed, the distribution flag is set to OFF. In contrast, if transmission of a card has not yet been completed, the distribution flag is set to ON. For instance, at a point time when deliver of a card has been completed, delivery of the card on the next specified delivery date has not yet been determined. Hence, the distribution flag is set to ON. When only a reservation to be described later has been arranged for delivery of a card, the distribution flag remains ON. When “DELIVERY” is selected on a delivery instruction screen T6 to be described later or on either a simplified delivery instruction screen T11 or T13 to be described later, the distribution flag is set to OFF. A card for which a distribution flag is set to OFF is to be sent on a predetermined delivery date. A state in which a distribution flag remains OFF corresponds to a delivery-determined mode, and a state in which a distribution flag remains ON corresponds to a delivery-pending mode.

In a password mode, data pertaining to a password to be supplied to a destination user is stored in the entry “password.” If a delivery mode fits a mode other than a password mode, a password is not stored.

The “card number” represents a number assigned to a card image selected by the distributor user from card files stored in the display data storage section 105 for setting a card. The card number can be said to be information for specifying the card selected by the distributor user. In a text transmission mode, only text data are transmitted, and data assigned a card number are not stored. Further, information concerning details of a message entered by the user or information for specifying a message selected on an input screen is stored in the entry “message.”

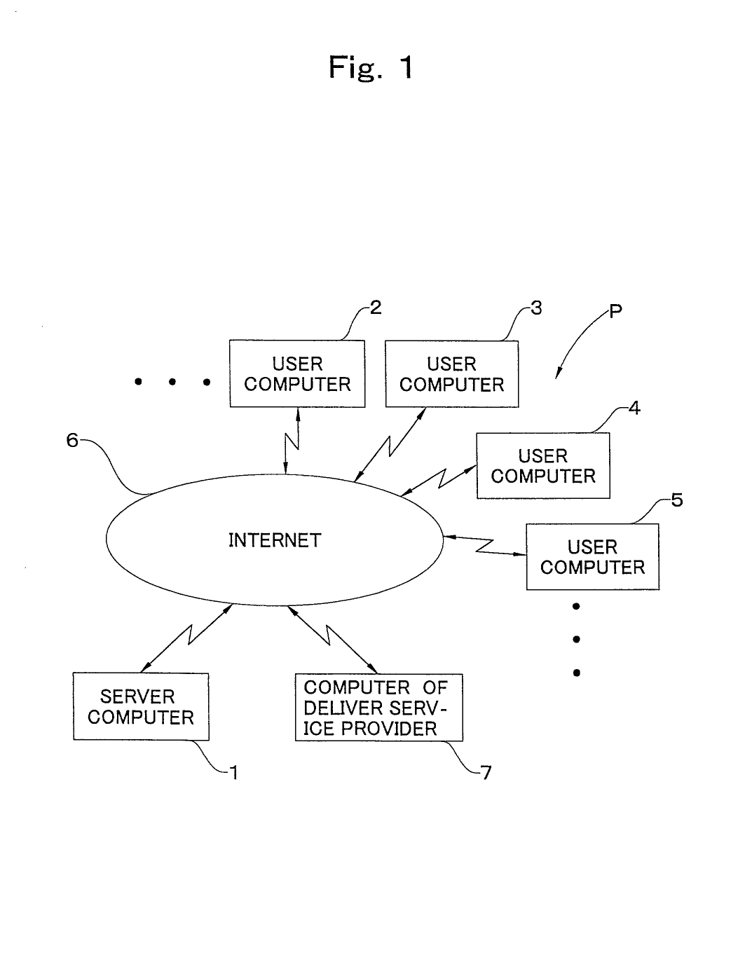

Further, information concerning a mode at the time of delivery of a card is stored in the entry “card.” More specifically, information for identifying a current mode, such as a password mode, a text transmission mode, an html transmission mode, and a printout delivery mode, is stored in the entry “mode.” In the password mode, a mail is sent to a destination user, to thereby inform the designation user that a card has been sent to the destination user and that the destination user is desired to access a predetermined URL and browse the URL using a password, by providing the destination user with the URL with the password. In the text transmission mode, a message is transmitted to a destination user in text form. In an html transmission mode, a message and other information are sent to a destination user in the form of a mail of html form. In either a text transmission mode or a html transmission mode, a file including data pertaining to a card image may be attached to a mail. In a printout delivery mode, a card is printed by use of the printer 108. The thus-printed card is delivered by means of postal service. Alternatively, a printed card may be delivered to a destination user by means of sending predetermined information to an outside delivery service provider. Provided that an outside delivery service provider has a computer 7 (see FIG. 1), data pertaining to a card to be printed and information concerning the address of a destination are transmitted to the computer 7 by way of an interface. The outside delivery service provider prints the card and delivers the thus-printed card to the address. Further, it may be the case that the outside delivery service provider merely prints a card, and another service provider delivers the thus-printed card to the address.

In either the text transmission mode or the html transmission mode, a message is primarily transmitted. Hence, there may conceivably arise a case in which no card image is displayed. Throughout the specification, such a situation also falls within the range of concept of “card.” Alternatively, music data may be transmitted along with a card, thus providing a destination user with music. For instance, in the case of a password mode, a musical selection is played when a card is displayed on the user's computer as a result of the user having accessed a predetermined URL.

The password mode corresponds to a “basic mode,” and the text transmission mode and the html transmission mode correspond to a mail mode.

Here, throughout the specification, unless otherwise specified, expressions “sending of a card” and “card delivery” mean “distribution of a card” and “transmission of a card,” as well as delivery of a card in any one of the foregoing modes. Particularly, an expression “transmission of a card” implies delivery of a card in the printout mode. The expression “transmission of a card” also implies “card delivery.” Here, a word “delivery” implies “transmission” and “distribution,” and a word “transmission” also implies “distribution.”

The temporary storage section 107 is for temporarily storing data and is used for temporarily storing the data delivered from a user computer.

The data storage section 104 acts as the storage device set forth. Particularly, the management table K acts as a “storage device for storing data required for sending a card to a predetermined destination for each card.”

The user computers 2 through 5 are computers which can be connected to the server computer 1 over the Internet. Each of the user computers 2 through 5 is equipped with a display section, e.g., a CRT or an LCD, and an input section such as, a keyboard or a mouse. The user computers 2 through 5 may be implemented by portable information terminals and portable cellular phones, as well as by desktop personal computers.

An overall card distribution system P (see FIG. 1) is constructed of the server computer 1, the user computers 2 through 5, and the computer 7 of the outside delivery service provider.

Operation of the server computer 1 and that of the overall card distribution system P including the server computer 1 will now be described. Particularly, a card delivery control method will now be described.

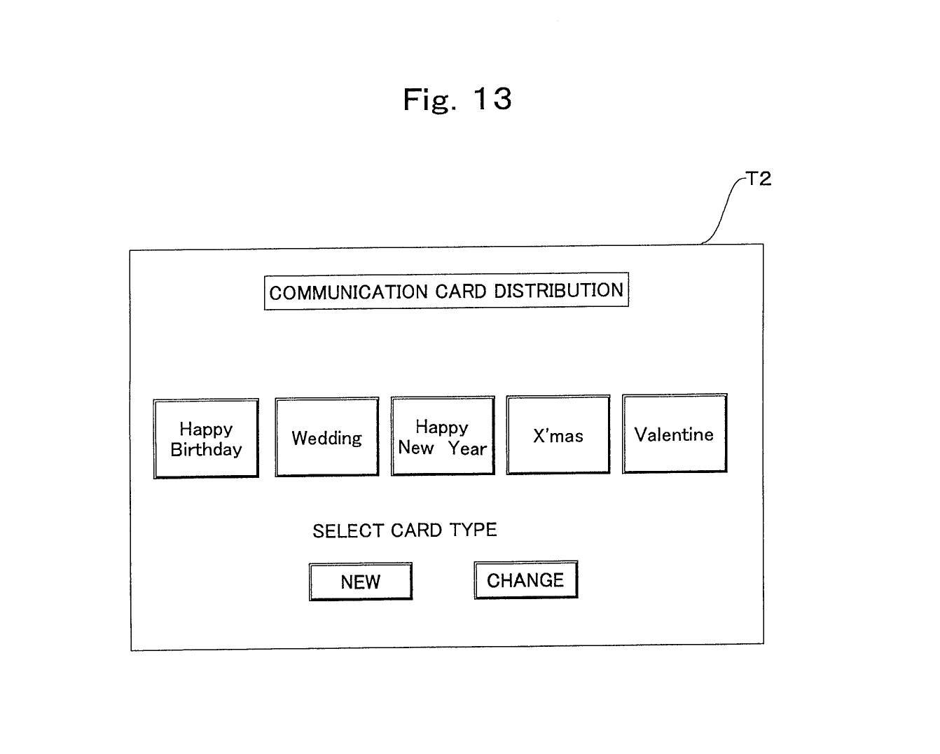

When the server computer 1 causes the user computers 2 through 5 to each display a screen, such as an initial screen T1, the server computer 1 transmits display data pertaining to a screen to the user computers 2 through 5. Each of the user computers 2 through 5 that have received the display data displays the display data on a display section. In this regard, the same applies to each of screens to be described later (e.g., screens shown in FIG. 13 and subsequent drawings).

The data—which have been entered on a screen appearing on the user computer by means of a selection input operation or a writing input operation through clicking action—are delivered to the server computer 1. The data are further sent to the control section 101 by way of the I/O control section 102. In accordance with a predetermined program for detecting input data, the program being stored in the program storage section 13, contents of the input data are detected. Throughout the specification, unless otherwise specified, the word “input (or entry)” comprehensively covers the concept of input, including selection input and writing input. The thus-detected input data are temporarily retained by the control section 101 and stored in the data storage section 104. When a plurality of click buttons are displayed on a screen appearing on a user computer and when any one of the click buttons is selectable, selection is made by means of an input device, such as a mouse.

Determination, which will be described hereinbelow, is made primarily by the control section 101 in accordance with a program stored in the program storage section 103.

Throughout the specification, when the distributor user fails to perform a necessary input operation on any one of screens to be described below, an instruction for prompting the distributor user to perform an operation is preferably output to the user computer of the distributor user.

### (1) Basic Operation

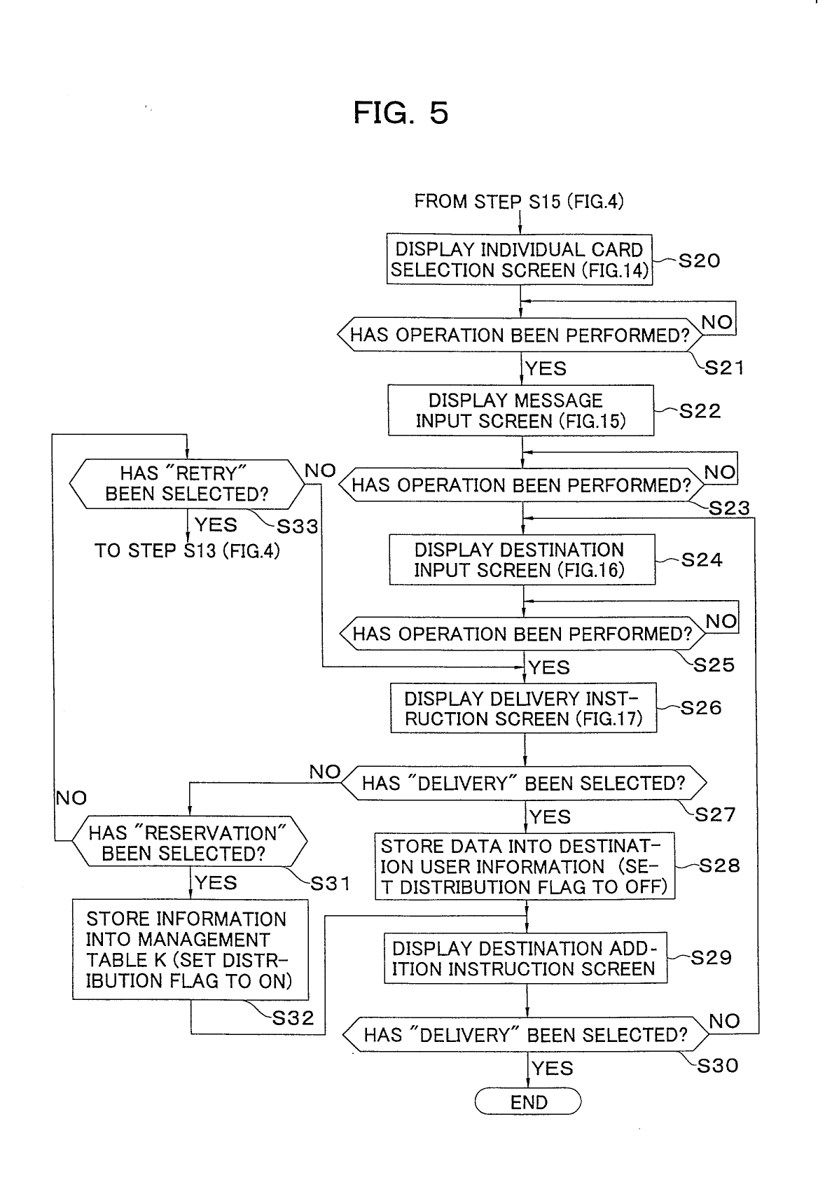

The basic card delivery operation of the sever computer 1 and that of the overall card distribution system P including the server computer 1 will now be described by reference to flowcharts shown in FIGS. 4 and 5 and screens shown in FIGS. 12 through 18.

It is assumed that a distributor user has accessed the server computer 1 over the Internet by use of the user computer 2. An initial screen T1 shown in FIG. 12 appears on the user computer 2 (S10). In the following description, the distributor user operating the user computer 2 performs operations as a card sender. Naturally, the card distribution system operates in the same manner even when a user operates a user computer other than the user computer 2.

The initial screen T1 enables entry of a password of the distributor user. When the distributor user has sent a card by accessing the server computer 1 in the past, a password must have been set by means of user setting. The password is entered on the initial screen T1. After entry of the password, button “GO TO” is clicked.

If no password is set, the user performs user registration. If no password is set because the distributor user has never sent a card in the past, the user newly performs user registration and acquires a password. More specifically, the user clicks a user registration button 300 appearing on the initial screen T1. When the user clicks the button 300, a screen for user registration (not shown) appears on the user computer 2. The user enters user information, such as the E-mail address, postal address, and name of the distributor user. Here, a password may be set by the distributor user himself, or a password automatically set by the server computer 1 may be displayed. Accordingly, a storage area for storing management information 200 concerning the distributor user is formed within the management table K. At this time, only the E-mail address, password, and the user information included in the distributor user information are stored as the management information 200. As mentioned above, after user registration and setting of a password have been completed, processing returns to the initial screen T1, where the user enters the password and clicks button “GO TO.”

When entry of the password and clicking of button “GO TO” have been performed, a determination is made as to whether or not the thus-entered password is valid (S11 and S12). If it have been determined that the password is valid, processing proceeds to step S13. In contrast, if the password is invalid, processing is terminated.

In step S13, a card type selection screen T2 (see FIG. 13) appears on the user computer 2. The card type selection screen T2 is for enabling selection of card type. More specifically, click buttons assigned to respective card types; that is, a click button “Birthday,” a click button “Wedding Ceremony,” a click button “New Year's Card,” a click button “Christmas,” and a click button “Valentines” are displayed, thereby enabling the user to select one by means of clicking the corresponding click button. Here, the “Wedding Ceremony” is correspond to the wedding card. Additionally, a click button “New” and a click button “Change” are also provided. The distributor user selects one by clicking the corresponding click button and further clicks either one of click buttons “New” or “Change.” When procedures for sending a new card are to be performed, the click button “New” is to be selected. When the card having already been registered is desired to be changed, the click button “Change” is to be selected.

When any one of the cards is selected, a determination is made as to whether either “New” or “Change” has been clicked (S14). When it have been determined that selection of a card have been performed, a determination is made as to whether or not “New” is selected. The following description is based on the assumption that “Birthday” and “New” have been selected.

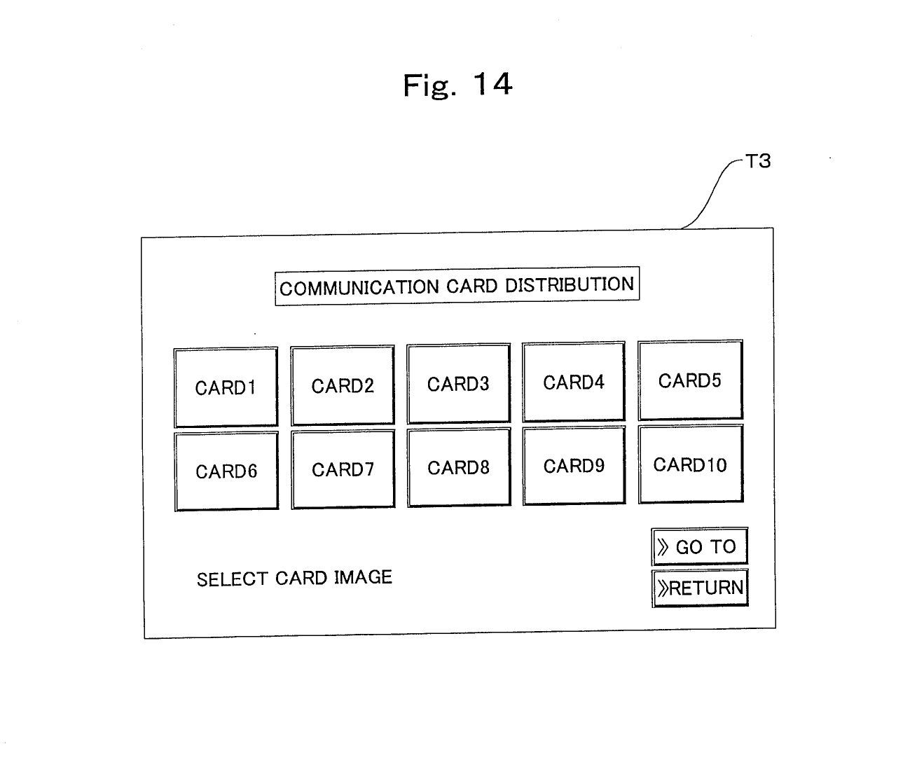

An individual card selection screen (see FIG. 14) appears on the user computer 2 (S20 shown in FIG. 5). Simultaneously, the information selectively entered on the card type selection screen T2 is delivered to the server computer 1 and is temporarily stored in the temporary storage section 107.

Card images representing a plurality of images of birthday cards are displayed in the individual card selection screen T3, thereby enabling selection of one from the images. Although images are illustrated simply as “Card 1” and “Card 2” in FIG. 14, card images are actually displayed on the screen. A plurality of image data sets pertaining to birthday cards are pasted in the form of click buttons to data pertaining to the individual card selection screen T3 from among the screen data stored in the display data storage section 105, thereby preparing and displaying the data pertaining to the individual card selection screen T3. Data pertaining to a plurality of card images of birthday cards are stored as card data in the display data storage section 105. The individual card images also act as click buttons. After having clicked a click button assigned to any one of the card images, the distributor user then clicks click button “GO TO.” Even when the user has selected another type of card other than the birthday cards on the card type selection screen T2, a similar individual card selection screen appears. As a matter of course, card images to be displayed on the screen differ in type from the images of birthday cards.

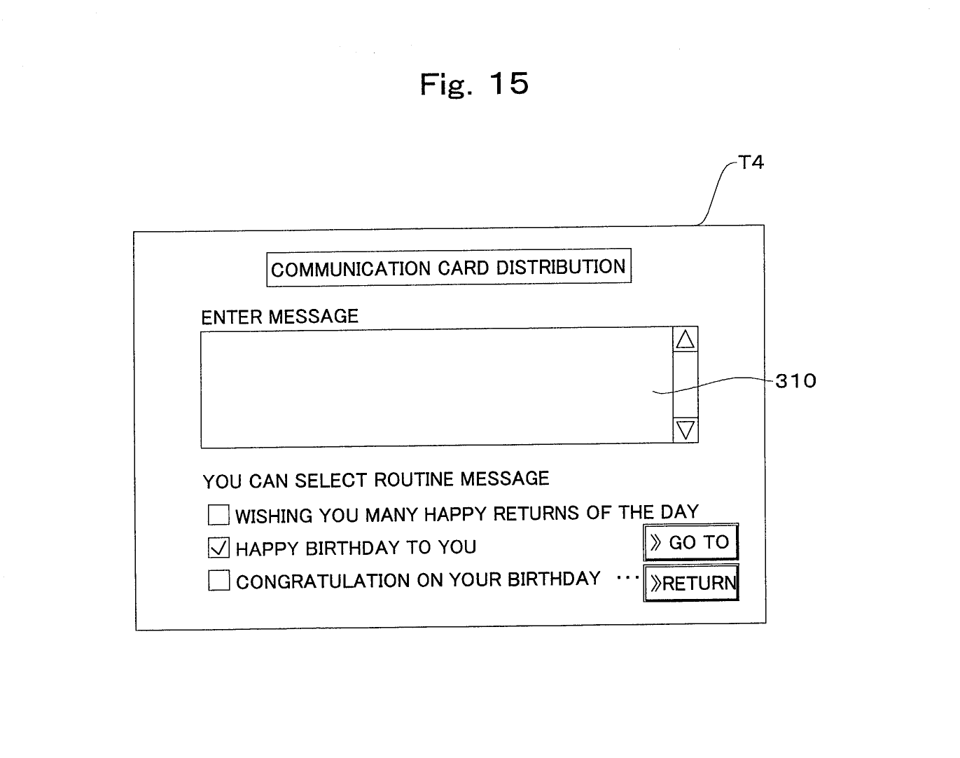

A determination is then made as to whether or not an operation for selecting any card image and an operation for clicking click button “GO TO” have been performed (S21). If it have been determined that these operations have been performed, a message input screen T4 (see FIG. 15) appears on the user computer 2 (S22). Simultaneously, the information selectively input on the individual card selection screen T3 is delivered to the server computer 1, and the data are temporarily stored in the temporary storage section 107.

The message input screen T4 is for enabling entry of a message. The message input screen T4 is provided with a message input field 310 for enabling the distributor user to enter a message, and routine expressions and click boxes for enabling the user to selectively enter a commonly-used expression. After having entered a message into the message input field 31 or clicked a commonly-used expression, the distributor user clicks a button “GO TO.” Routine expressions vary according to the type of a card.

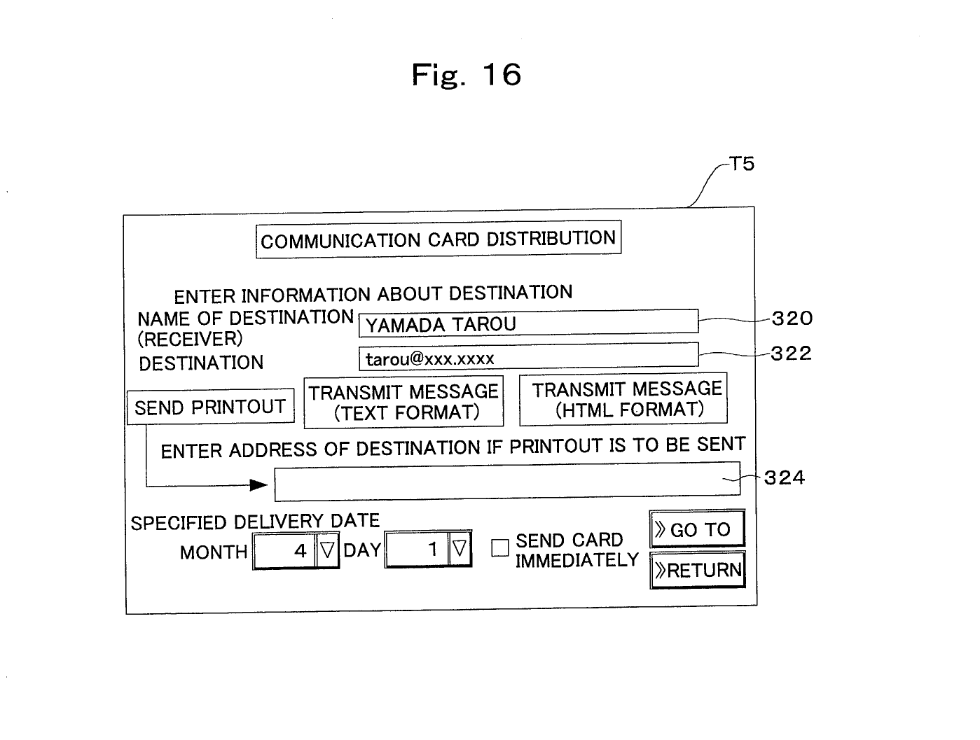

A determination is made as to whether or not an operation for entering a message into the message input field 31 or an operation for selecting a routine expression by clicking a corresponding click box, and an operation for clicking button “GO TO” have been performed (S23). If it have been determined that these operations have been performed, a screen T5 which enables entry of destination-related data and the like (hereinafter called a “destination input screen T5”) (see FIG. 16) appears on the user computer 2 (S24). Simultaneously, the information selected and input on the message input screen T4 is delivered to the server computer 1, and the data are temporarily stored in the temporary storage section 107.

The destination input screen T5 is for enabling entry of information about a destination, a delivery mode, and a specified delivery date. As fields for entering information about a destination, the destination input screen T5 is provided with an input field 320 for entering the name of a destination user and an input field 322 for entering the E-mail address of the destination user. Thus, the destination input screen T5 enables entry of the name of a destination user and the E-mail address thereof. Data to be entered in the input field 320 and the input field 322 correspond to the destination specification data.

As a delivery mode, a desired one can be selected from a plurality of modes. Specifically, the destination input screen T5 is provided with a click button “SEND PRINTOUT,” a click button “TRANSMIT MESSAGE (TEXT FORM),” and a click button “TRANSMIT MESSAGE (HTML FORM).” Here, the click button “SEND PRINTOUT” corresponds to the printout delivery mode. The click button “TRANSMIT MESSAGE (TEXT FORM)” corresponds to the text transmission mode. The click button “TRANSMIT MESSAGE (HTML FORM)” corresponds to the html transmission mode. When any one of the click buttons is clicked, a corresponding delivery mode is selected. If none of the click buttons is clicked, the password mode is selected. In other words, when selection of the password mode is desired, none of the click buttons is to be clicked. When the click button “SEND PRINTOUT” is clicked, the postal address of a destination is to be entered into an input field 324. Here, when “PRINTOUT DELIVERY” is clicked, entry of an E-mail address is not necessary.

A date can be entered into a box “SPECIFIED DELIVERY DATE,” and the destination input screen T5 is also provided with a click box for immediate delivery. In connection with cards, such as Christmas Cards, New Year's cards, and Valentine cards, which are determined to be delivered on specified dates, entry of a delivery date cannot be performed.

The destination input screen T5 may be arranged so as to enable entry of “TITLE OF MAIL” when a card is sent in the form of an electronic mail, as in the text transmission mode or the html transmission mode, to enable entry of the E-mail address and password of the distributor user, and to enable storage of the E-mail address and password into the management table K.

Preferably, explanations about how to perform input operations are displayed on the destination input screen T5. Particularly, displaying a statement about delivery (transmission) modes assigned respective click buttons on the destination input screen T5 is preferable.

After completion of entry operations on the destination input screen T5, a “GO TO” button is to be clicked.

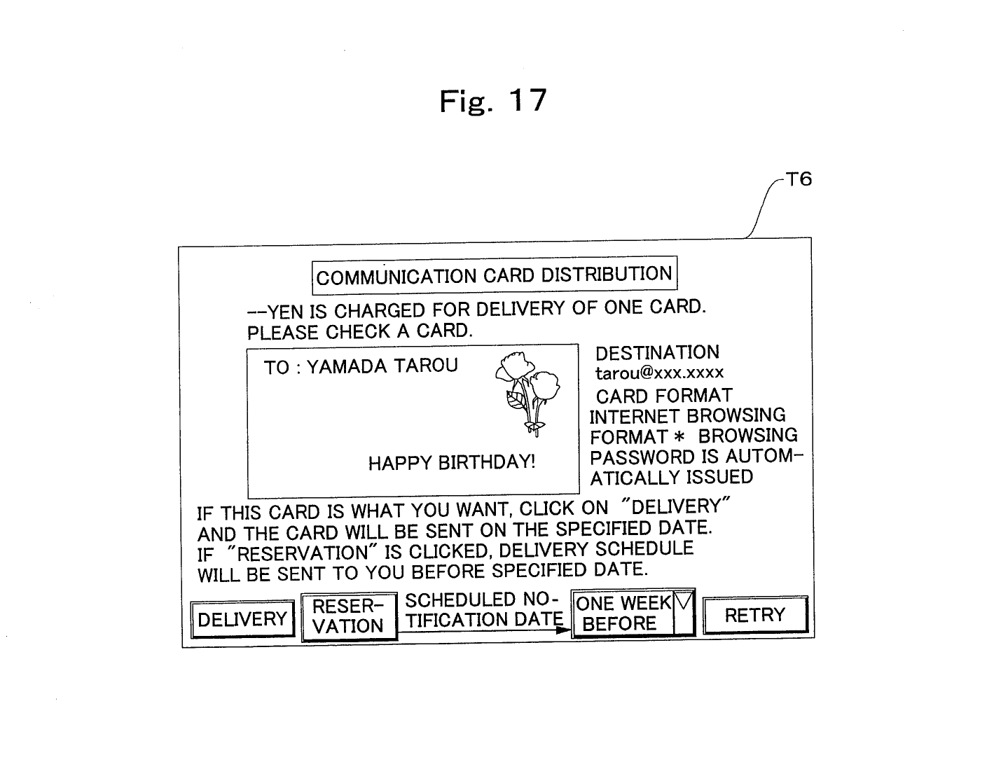

A determination is made as to whether or not an operation for entering required information and an operation for clicking the “GO TO” button have been performed on the destination input screen T5 (S25). If it have been determined that these operations have been performed, a screen T6 which enables entry of delivery instruction-related information (hereinafter called a “delivery instruction screen T6”) (see FIG. 17) appears on the user computer 2 (S26). Here, required information comprises the name of a destination user, the E-mail address of the user, and a specified delivery date. Simultaneously, the information selected and input on the destination input screen T5 is delivered to the server computer 1, and the data are temporarily stored in the temporary storage section 107.

The delivery instruction screen T6 displays a card image to be sent to the destination user, the E-mail address of the destination, and the delivery mode and is provided with a click button “DELIVERY,” a click button “RESERVATION,” and a click button “RETRY.” The user can select one from these buttons. Further, billing data are also displayed on the screen T6. The card image appearing on the screen T6 is prepared in accordance with the data that have been entered thus far by means of selection or description on the screens.

On the destination instruction screen T6, the distributor user selects any one of the click buttons “DELIVERY,” “RESERVATION,” and “RETRY,” by means of clicking. When the distributor user sends a card, the user selects the “DELIVERY” button. If the user desires to put delivery of a card on hold, the user selects the “RESERVATION” button. If the user again desires to perform input operations from the beginning, the user selects the “RETRY” button.

The individual card selection screen T3 (step S20), the message input screen T4 (step S22), the destination input screen T5 (step S24), and the delivery instruction screen T6 (step S26) act as application input screens. When the data pertaining to the individual card selection screen T3 through the delivery instruction screen T6 are delivered to the user computer 2, the control section 101 and the I/O control section 102 operate in accordance with programs stored in the program storage section 103. At this time, the control section 101, the I/O control section 102, and the program storage section 103 act as an application input screen data transmission device. In connection with steps S20, S22, S24, and S26, a step for transmitting data pertaining to respective screens to the user computer corresponds to an application input screen data transmission step.

In accordance with the result of selection of a button from the “DELIVERY,” “RESERVATION,” and “RETRY” buttons, the following processing operations are performed.

A determination is made as to whether or not “DELIVERY” has been selected on the delivery instruction screen T6 (S27). If it have been determined that “DELIVERY” have been selected, the information entered thus far; that is, information retained in the temporary storage section 107, is stored in the destination user information stored in the management table K (S28).

In connection with the destination user information 204 registered in the management table K shown in FIG. 3, information about the name of a destination user and the E-mail address thereof, which has been entered on the destination input screen T5, is stored in the field “DESTINATION SPECIFICATION DATA.” Particularly, when selection of “DELIVER PRINTOUT” and entry of the postal address of a destination have been performed, data pertaining to the postal address are stored in the field “DESTINATION SPECIFICATION DATA.” Here, when “PRINTOUT DELIVERY” is selected and when both an E-mail address and a postal address are entered, information about the thus-entered E-mail and postal addresses is naturally stored. Information about the name of an event corresponding to the type of the card selected on the card type selection screen T2 is stored in the field “CARD TYPE & SPECIFIED DELIVERY DATE.” Further, the information about a specified delivery date entered on the delivery input screen T5 is stored.

In connection with the field “DELIVERY SCHEDULE NOTIFICATION DATE,” a delivery schedule notification date is automatically set in accordance with the type of a selected card. In connection with the field “DELIVERY FLAG,” since delivery of the card has not yet been completed at this point in time, a delivery flag is set to OFF. In connection with the field “PASSWORD,” a password to be sent to a destination user is automatically set when a card is delivered to the destination user. A password is required only when the delivery mode is a password mode, and hence no password is set in a mode other than the password mode. In connection with the field “CARD NUMBER,” a card number to be used for specifying the card selected on the individual card selection screen T3 is stored. In connection with the field “MESSAGE,” a message entered on the message input screen T4 is stored. In the case of everyday expressions, information available for specifying an everyday expression may be stored in the field “MESSAGE.” In connection with the field “MODE.” information about the delivery mode selected and entered on the destination input screen T5 is stored. In FIG. 3, the word “pass” designates a password mode, and the word “html” designates an html transmission mode. Further, the word “text” designates a text transmission mode, and the word “post” designates a printout delivery mode.

In a case where the button “DELIVER IMMEDIATELY” is selected and clicked on the destination input screen T5, a card is delivered to the destination user in a predetermined mode in step S28.

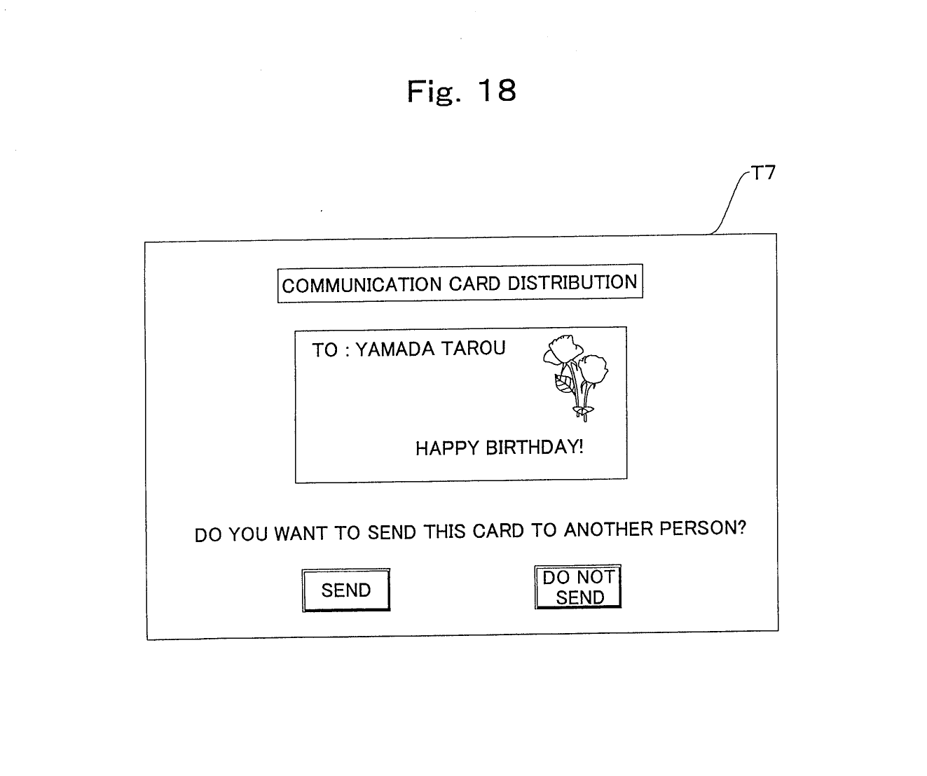

As mentioned above, after storage of information into the management table K in step S28, a destination addition instruction screen T7 (FIG. 18) is displayed (S29). This screen T7 is for enabling a check as to whether or not a card analogous to that for which delivery has been instructed is to be sent to another destination user. The screen T7 is provided with click buttons “SEND” and “DO NOT SEND,” thereby enabling the distributor user to select one of them. At this time, the image of the card for which delivery has been instructed is displayed on the screen T7.

A determination is made as to whether or not the button “SEND” has been selected on the screen T7 (S30). If it have been determined that the button “SEND” have been selected, processing returns to step S24, where the destination input screen T5 is displayed, thereby enabling entry of the E-mail address of another destination user. In contrast, if the button “DO NOT SEND” has been selected, processing is terminated.

As mentioned above, if the button “DELIVERY” has been selected on the screen T6, the card is to be delivered on a specified delivery date, as will be described in detail later.

If it has been determined that the button “DELIVERY” has not been selected in step S27, a determination is made as to whether or not “RESERVATION” has been selected (S31). If it have been determined that the button “RESERVATION” have been selected, the information that has been entered thus far; that is, the information retained in the temporary storage section 107, is stored in the destination user information stored in the management table K. Storage of the information into the management table K is performed in the same manner as performed in step S28. Here, the “DISTRIBUTION FLAG” is set to ON.

As mentioned above, after storage of information into the management table K has been completed in step S32, processing proceeds to step S29, where the screen T7 (FIG. 18) is displayed. In the same manner as mentioned previously, it is ascertained whether or not the card is to be sent to another distribution user. If the card is to be sent to another destination user, processing returns to the destination input screen T5.

If “RESERVATION” has been selected on the delivery instruction screen T6, a delivery schedule notification mail (i.e., confirmation mail) will be sent to the distributor user, as will be described in detail later.

The click button “DELIVERY” on the delivery instruction screen T6 corresponds to a delivery-determined mode, and the click button “RESERVATION” on the same screen corresponds to a delivery-pending mode.

When it is determined in step S31 that “RESERVATION” has not been selected, a determination is made as to whether or not “RETRY” has been selected (S33). If it have been determined that “RETRY” have been selected, processing returns to step S13, where the card type selection screen T2 is displayed. When “RETRY” has been selected, the data retained by the temporary storage section 107; that is, the data entered on the screens, are not stored in the management table K.

If neither “DELIVERY” nor “RESERVATION” is selected on the delivery instruction screen T6, the information that has been entered thus far; i.e., the data stored in the temporary storage section 107, is not stored in the management table K. When connection to the server computer 1 has been disconnected before “DELIVERY” or “RESERVATION” is selected, the information stored in the temporary storage section 107; i.e., the information which has been entered thus far, is erased at a point in time when the user computer is disconnected from the server computer 1.

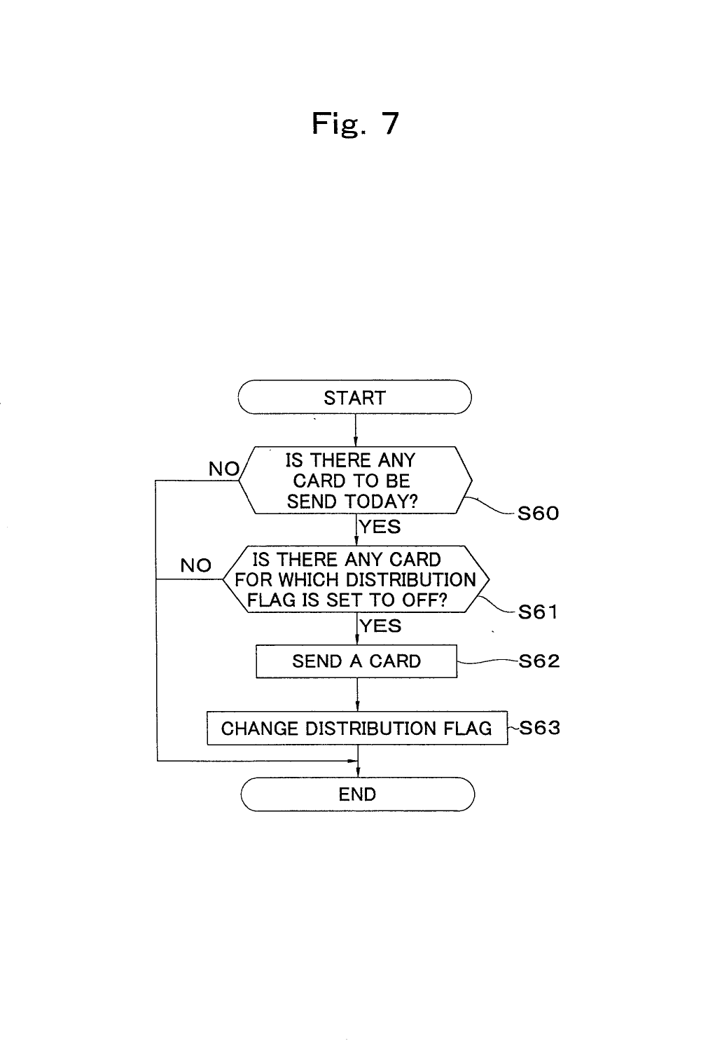

A card delivery operation of the card distribution system will now be described by reference to FIG. 7. A determination is made at a predetermined time every day as to whether or not today (i.e., a day on which a determination is made) corresponds to a specified delivery date (S60). More specifically, the control section 101 makes a determination as to whether or not there are cards which are specified to be delivered today, in the management table K.

The control section 101 also makes a determination is made as to whether or not cards for which a distribution flag is set to OFF are included in the cards specified to be delivered today (S61).

When it is determined that there are cards which are specified to be delivered today (i.e., the day on which a determination has been made) and for which a distribution flag is set to OFF, there is performed processing for sending the cards in predetermined modes; i.e., modes set for the respective cards (S62).

In the case of a password mode, an electronic mail is sent to a destination user, thereby stating that a card has been delivered to the destination user and that the destination user is desired to access a predetermined URL and browse the URL using a password, by providing the destination user with the URL and the password. The destination user who has received this mail accesses the URL and enters the password, thereby browsing a card sent from the distributor user on the screen. The card is delivered in this manner.

In the case of a text transmission mode, a message is transmitted to a destination user in the form of an electronic mail of text form. Further, in the case of an html transmission mode, a message and other information are sent to a destination user in the form of an electronic mail of html form. The destination user who has received the mail receives a card by means of receiving the electronic mail. In the case of a printout delivery mode, a card is printed by the printer 108, and the thus-printed card is delivered to a destination user by means of postal service.

When processing required for delivery a card is performed, the control section 101 and the I/O control section 102 operate in accordance with a program stored in the program storage section 103. In this case, the control section 101, the I/O control section 102, and the program storage section 103 act as a card delivery device. Processing pertaining to step S62 corresponds to “processing for sending a card to a destination” and a “card delivery step.”

When delivery of the card has been completed, the distribution flag is set to ON (S63).

For example, in connection with a case where data are stored in the management table K, as shown in FIG. 3, if the day on which the above-described determination is made falls on April 1^{st}, a birthday card addressed to “YAMADA Taro”—which is specified to be delivered on April 1^{st} and for which a distribution flag is set to OFF-is delivered.

Since certain types of cards, such as Christmas cards, are to be delivered on respective predetermined dates, they are delivered on these delivery dates. When the same card has been registered for a plurality of destination users, the card is distributed to the destination users.

### (2) Changes in card delivery history information

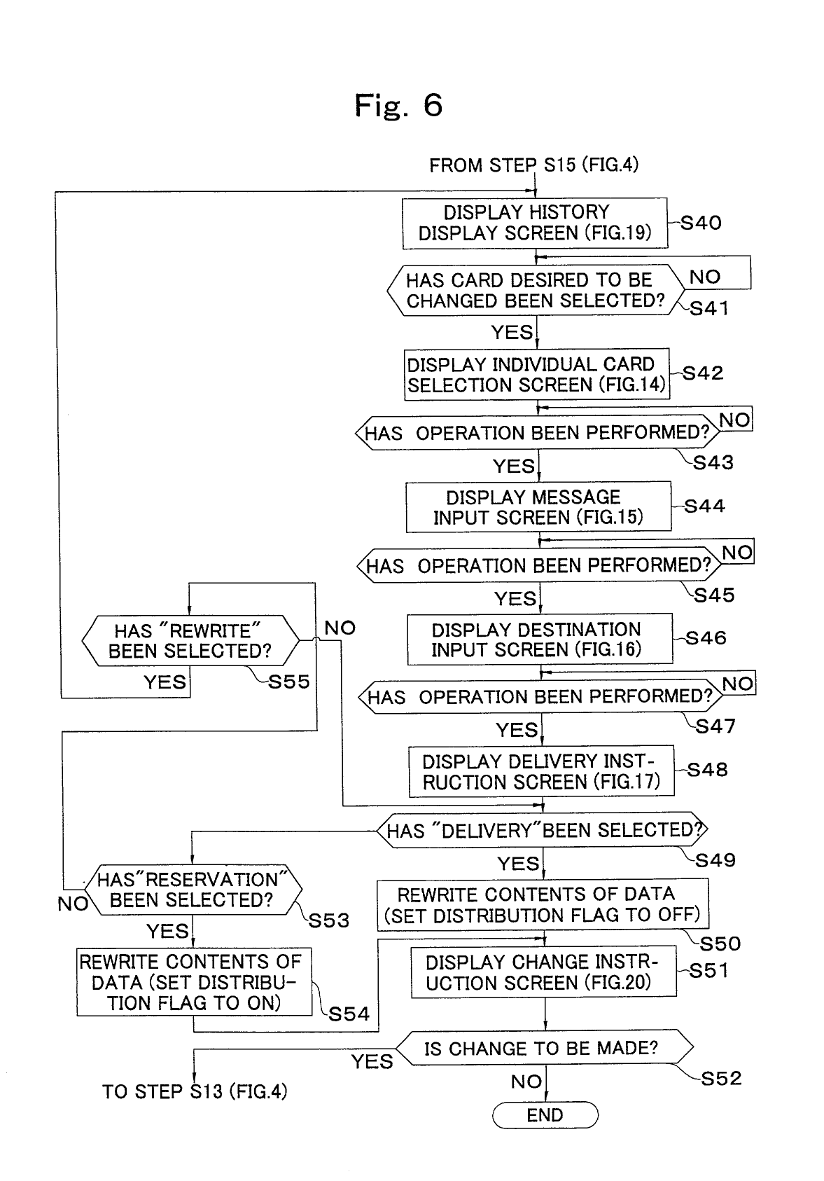

There will now be described a case where “CHANGE” has been selected on the card type selection screen T2. In this case, processing proceeds from step S15 to step S40 (see FIG. 6).

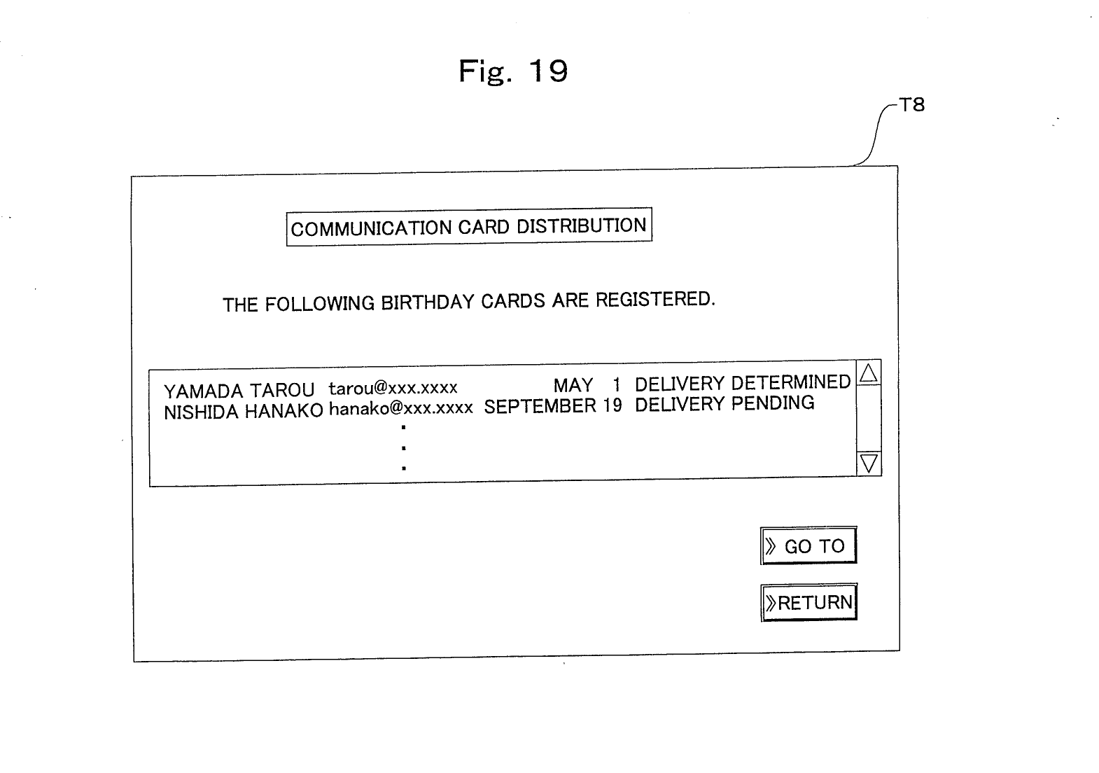

In step S40, a history display screen T8 (FIG. 19) appears on the user computer 2. The history display screen T8 is for displaying card information stored in the management table K in connection with the type of card selected on the card type selection screen T2. As shown in FIG. 19, there is displayed information; that is, the names and E-mail addresses of destination users to which a card is to be delivered, specified delivery dates, and information as to whether or not delivery of the card to the destination users has been determined. In the management table K, the control section 101 retrieves the selected type of card (e.g., a birthday card) from among the destination user information belonging to the distributor user, thereby displaying the above-described information pieces. More specifically, a history about whether or not the distributor user has sent or made reservation for delivery of the card of selected type in the past is displayed. When the distribution flag is set to ON, “DELIVERY PENDING” is displayed. In contrast, when the distribution flag is set to OFF, “DELIVERY DETERMINED” is displayed. The card assigned “DELIVERY DETERMINED” indicates that the card is to be delivered on a predetermined specified delivery date. The card assigned “DELIVERY PENDING” means that delivery of the card on a coming specified delivery date has not yet been determined as a result of the card having already been delivered or “RESERVATION” having been selected on the delivery instruction screen T6.

The history display screen T8 shown in FIG. 19 shows a situation in which “BIRTHDAY” has been selected on the card type selection screen T2 against the backdrop of the management table K being registered in the manner as shown in FIG. 3. When another type of card is selected on the card type selection screen T2, a history about whether or not the distributor user has sent or made a reservation for delivery of the card of selected type in the past is displayed.

The history display screen T8 acts as a selection input screen. When the data pertaining to the history display screen T8 are sent to the user computer 2, the control section 101 and the I/O control section 102 operate in accordance with a program stored in the program storage section 103. At this time, the control section 101, the I/O control section 102, and the program storage section 103 act as a selection input screen data transmission device. In connection with step S40, a step for transmitting to the user computer 2 data pertaining to the history display screen T8 corresponds to a selection input screen data transmission step.

A delivery-determined mode and a delivery-pending mode are displayed on the history display screen T8. The delivery-pending mode may be further divided into a “DELIVERED” mode and a “RESERVED” mode, and either of these may be displayed in place of the delivery-pending mode. Here, the “DELIVERED” mode means that the distribution flag is set to ON as a result of a card having been delivered very recently. The “RESERVED” mode means that the distribution flag is set to OFF as a result of a reservation operation having been performed very recently. In the case of “delivery-pending” mode, a flag other than the distribution flag is required for identifying whether or not the card has been delivered or a reservation has been arranged for delivery of the card.

Glancing at the history display screen T8, the distributor user selects a card for which he desires to make changes, by clicking the card. Both a card whose delivery has been determined and a card whose delivery is pending are selectable.

A determination is made as to whether or not selection of a card desired to be changed has been made (S41). If it have been determined that selection have been made, the individual card selection screen T3 (FIG. 14) appears on the user computer 2 (S42). Since the individual card selection screen T3 has already been described, repetition of its explanation is omitted. In this case, images of cards which have already been registered and assigned numbers are highlighted on the individual card selection screen T3. For instance, the card addressed to “YAMADA Taro” shown in FIG. 19 is assigned card number A2 according to FIG. 3. Hence, a card image corresponding to A2 is highlighted. Thus, the distributor user can ascertain the images of the cards which have already been stored. When the distributor user desires to change the image of the card, the user can select another card image on the individual card selection screen T3. If no change to the card image is required, the user clicks only the button “GO TO.”

A determination is made as to whether or not at least an operation for clicking the button “GO TO” has been performed (S43). If it have been determined that the operation have been performed, the message input screen T4 (FIG. 15) appears on the user computer 2 (S44). Simultaneously, the information which has newly been selectively entered on the individual card selection screen T3 is delivered to the server computer 1 and is temporarily stored in the temporary storage section 107.

Since the message input screen T4 has already been described, repetition of its explanation is omitted. The messages which have already been stored appear on the message input screen T4. For example, in the case of the birthday card addressed to “YAMADA Taro” shown in FIG. 19, the everyday expression “Happy birthday!” is stored. As shown in FIG. 15, the message input screen T4 is displayed while a click box assigned to the everyday expression is checked. Thus, the distributor user can ascertain the messages which have already been registered. In the case of a card for which a reservation has been arranged, the distributor user can modify improper expressions while ascertaining the stored message. If the distributor user desires to change the registered message to another one, the distributor user enters a different message on the message input screen T4. If no changes to the message are required, the user can click only the button “GO TO.”

A determination is made as to whether or not at least an operation for clicking the button “GO TO” has been performed (S45). If it have been determined that the operation have been performed, the destination input screen T5 (FIG. 16) appears on the user computer 2 (S46). Simultaneously, the information which has newly been entered on the message input screen T4 is delivered to the server computer 1 and is temporarily stored in the temporary storage section 107.

Since the destination input screen T5 has already been described, repetition of its explanation is omitted. The data which have already been stored appear on the destination input screen T5. For example, in the case of the birthday card addressed to “YAMADA Taro” shown in FIG. 19, the name and E-mail address of “YAMADA Taro” are displayed. Here, in the case of the printout mode, a postal address is displayed into the input field 324. In connection with the delivery mode, the click button corresponding to the mode stored in the management table K is highlighted. As a result, the distributor user can ascertain information about the destination which has already been stored. If the distributor user desires to change the contents of the stored data, all the user has to do is to enter new data. If no changes are required, the user clicks only the button “GO TO.”

When the distributor user has performed an operation for changing both the name and E-mail (or a postal mail) address of the destination user on the destination input screen T5, preferably there is displayed a screen for querying whether the data are to be rewritten or changes are to be added to the data stored in the management table K, at a point in time when the button “GO TO” is clicked. If addition is selected, data pertaining to a new card are added to the management table K in step S50 or S54. When changes to the name and E-mail (or postal mail) address of the destination user are made, an operation for changing can be facilitated further, by means of adding to the management table K data pertaining to new cards.

A determination is made as to whether or not at least an operation for clicking the button “GO TO” has been performed (S47). If it have been determined that the operation have been performed, the deliver instruction screen T6 (FIG. 17) appears on the user computer 2 (S48). Simultaneously, the information which has newly been entered on the destination input screen T5 is delivered to the server computer 1 and is temporarily stored in the temporary storage section 107.

Since the delivery instruction screen T6 has already been described, repetition of its explanation is omitted. Altered data appear on the delivery instruction screen T6. If the card can be delivered in its present form, the distributor user clicks the button “DELIVERY.” If the user desires to hold delivery of the card, the user clicks the button “RESERVATION.” If the user desires to prepare a card again from the beginning, the user clicks the button “RETRY.”

Here, step S46 may be skipped, and processing may proceed from step S45 to step S48. In this case, information concerning the name and E-mail address (in the case of the printout mode, “postal mail address” or “postal and E-mail addresses”) of the destination user, the delivery mode, and the specified delivery data remains intact.

The individual card selection screen T3 (step S42), the message input screen T4 (step S44), the destination input screen T5 (step S46), and the delivery instruction screen T6 (step S48) act as correction input screens. When the data pertaining to the individual card selection screen T3 through the delivery instruction screen T6 are delivered to the user computer 2, the control section 101 and the I/O control section 102 operate in accordance with programs stored in the program storage section 103. At this time, the control section 101, the I/O control section 102, and the program storage section 103 act as a correction input screen data transmission device. In connection with steps S42, S44, S46, and S48, a step for transmitting to the user computer data pertaining to respective screens corresponds to a correction input screen data transmission step.

In accordance with which of the click buttons “DELIVERY,” “RESERVATION,” and “RETRY” has been selected, the following processing operations are performed.

A determination is made as to whether or not “DELIVERY” has been selected on the delivery instruction screen T6 (S49). If it have been determined that “DELIVERY” have been selected, the data stored in the management table K are rewritten in accordance with the information which has been retained in the temporary storage section 107 thus far, and the distribution flag is set to OFF (S50). In other words, the data stored in the management table K are rewritten to the data which have been entered on at least any one of the screen of the individual card selection screen T3, the message input screen T4, the destination input screen T5, and the delivery instruction screen T6. For example, if the image of the birthday card addressed to “YAMADA Taro” has been changed, an altered card number is stored. Alternatively, if the delivery mode has been changed to a printout mode from another mode, the postal address of the destination user is added to the destination specification data stored in the management table K. If the delivery mode has been changed to a password mode from another mode, password data are to be added to the field “PASSWORD” in the management table K. Since the distribution flag is switched to OFF at this time, a card is to be sent to the destination user on the next specified delivery date.

In a case where the contents of the data stored in the management table K are changed, the control section 101 operates in accordance with a program stored in the program storage section 103. At this time, the control section 101 and the program storage section 103 act as a stored data alteration device. Further, step S50 corresponds to a stored data alteration step.

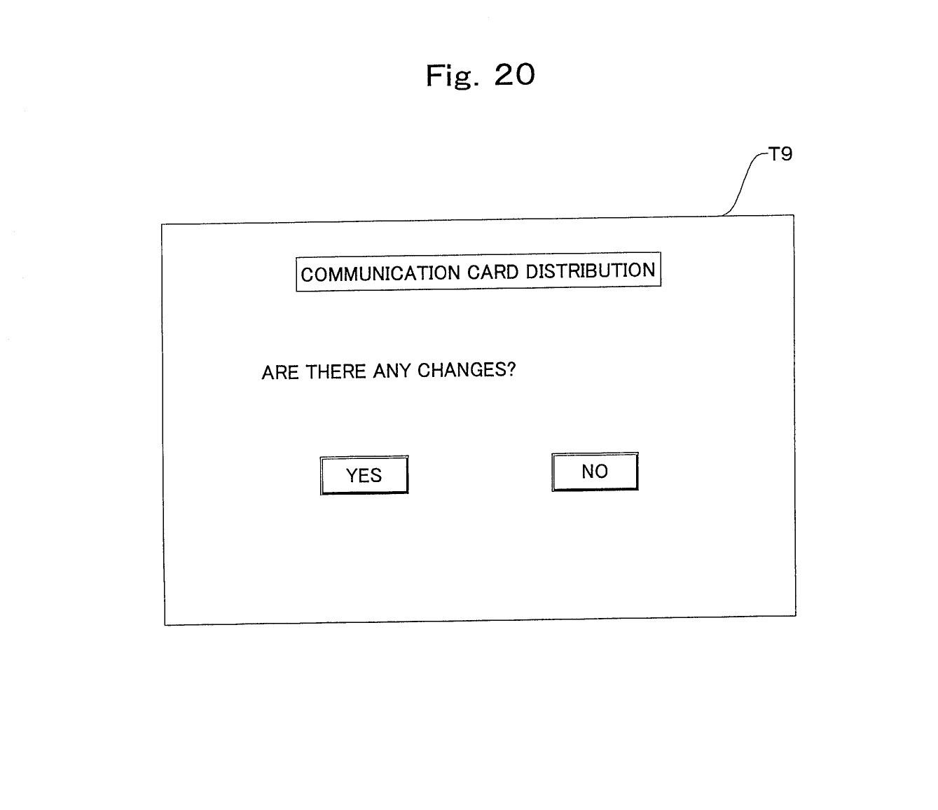

After rewriting of the information stored in the management table K has been completed, a change instruction screen T9 (FIG. 20) is displayed (S51). The change instruction screen T9 is for checking whether or not a change is to be made to other types of cards. The change instruction screen T9 is provided with click buttons “YES” and “NO.” If a change is desired, “YES” is to be selected. If no change is desired, “NO” is to be selected.

A determination is made as to whether or not “YES” or “NO” has been selected (S52). When it have been determined that the click button “YES” have been selected, processing returns to step S13, where the card type selection screen T2 is displayed. The distributor user selects the type of card for which he desires to make a change. Subsequent operations are the same as those mentioned previously. In a case where there is no card for which the user desires to make a change, processing is terminated.

When it has been determined in step S49 that “DELIVERY” has not been selected, a determination is made as to whether or not “RESERVATION” has been selected (S53). When it have been determined that “RESERVATION” have been selected, the data stored in the management table K are rewritten on the basis of the data retained in the temporary storage section 107, and the distribution flag is set to ON (S54). Rewriting of the data stored in the management table K is performed in the same manner as in step S50. Here, however, “DISTRIBUTION FLAG” is set to ON.

When rewriting of the data stored in the management table K has been completed in step S54, processing proceeds to step S51, where the change instruction screen T9 (FIG. 20) is displayed.

There may be a case where data pertaining to cards may be added to the data stored in the management table K in steps S50 and S54. In other words, when the distributor user has performed an operation for making changes to both the name and E-mail address of a destination user on the destination input screen T5, data pertaining to a new card are added to the data stored in the management table K when the distributor user has instructed addition.

When it has been determined in step S53 that “RESERVATION” has not been selected, a determination is made as to whether or not “RETRY” has been selected (S55). When it have been determined that “RETRY” have been selected, processing returns to step S40, where the history display screen T8 is displayed. When “RETRY” has been selected, the data stored in the management table K are not rewritten on the basis of the data retained in the temporary storage section 107.

As mentioned above, the change function according to the present invention enables changes to data pertaining to each of the cards, by means of merely changing required data without involvement of entry of the data used for sending a card. Even when the distributor user desires to make changes to the contents of the card or a destination, the only requirement is that the user enter only data pertaining to items to be changed. The card can be used again for delivery the next time with only changes to required items. For instance, if the distributor user desires to change a message, the user is required to change only the message on the message input screen T4. If the E-mail (or postal) address of the destination user has been changed, the distributor user rewrites only the E-mail (postal) address on the destination input screen T5. In connection with a card whose delivery is pending and which remains in a reserved state, contents of the card can be changed readily.

In the above description, when the distributor user selects the type of card and “CHANGE” on the card type selection screen T2, the history display screen T8 appears. Even in connection with a single distributor user, the history display screen varies according to the type of card. Here, all the cards registered for the distributor user may be displayed on a single history display screen 8 without regard to the types of cards. The history display screen 8 may be displayed for each destination user without identifying the type of card.

### (3) Delivery schedule notification mail

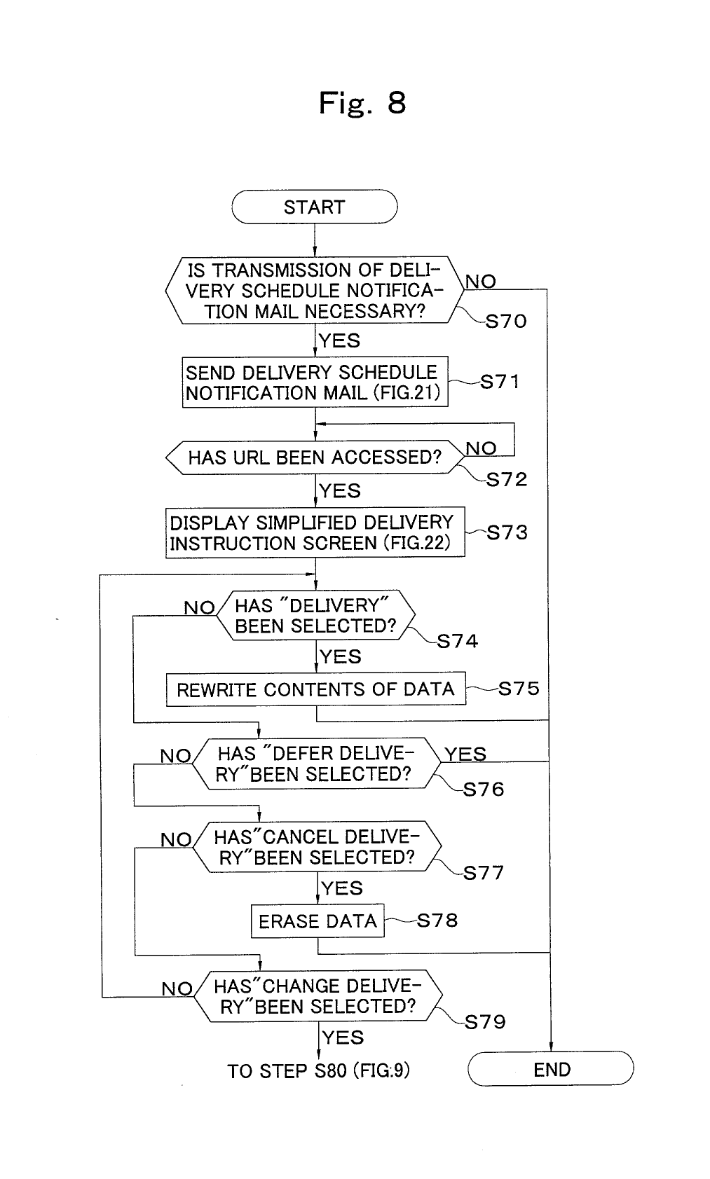

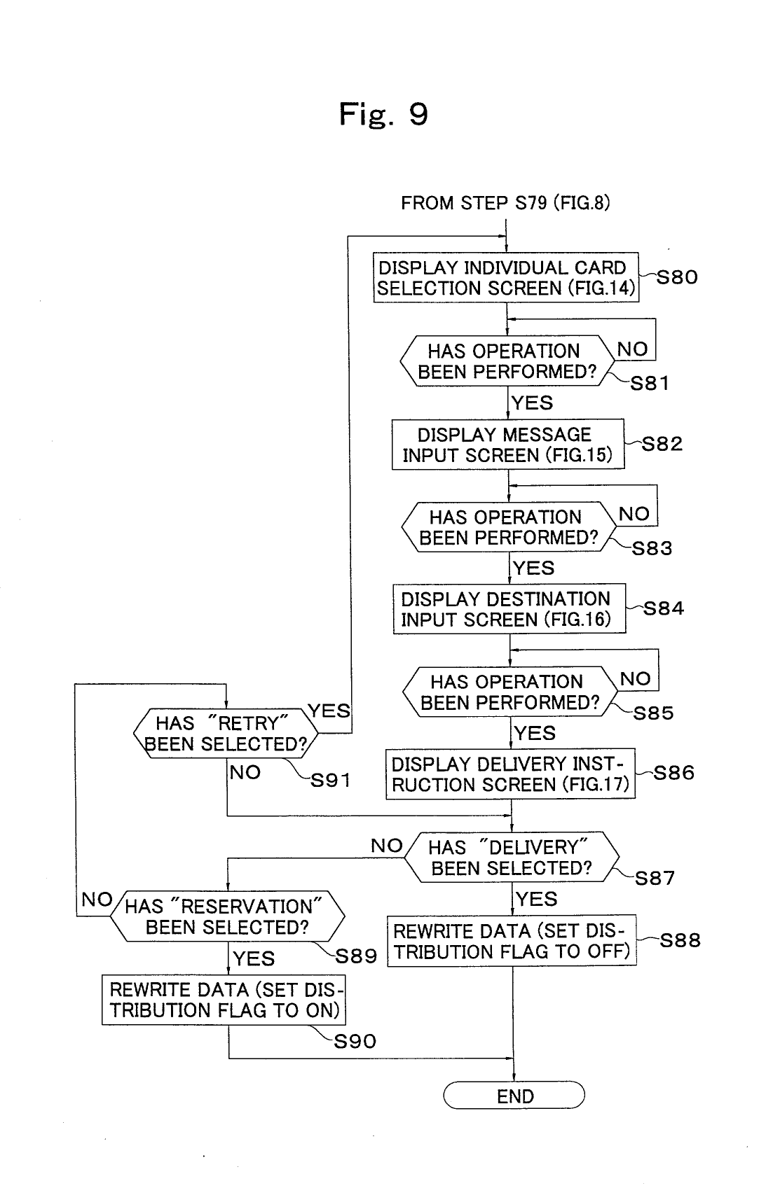

Transmission of a delivery schedule notification mail will now be described by reference to FIGS. 8 and 9. When “RESERVATION” has been selected on the delivery instruction screen T6 or when a card of the same type as that which will be sent this time has already been sent to the same destination user, the delivery schedule notification mail is to be transmitted.

First, transmission of a delivery schedule notification mail with regard to certain types of cards whose delivery dates differ from one from another, such as a birthday card or a wedding card, will be described by reference to FIGS. 8 and 9.

At a predetermined time every day a determination is made as to whether or not sending of a delivery schedule notification mail (may also be called an “information mail” ) is necessary (S70). More specifically, there is made a determination as to whether or not cards whose delivery schedule notification dates fall on today (i.e., a day on which a determination is made) include cards for which the distribution flag is set to ON. In other words, a determination is made in the management table K as to whether or not cards whose delivery schedule notification dates fall on today include cards for which the distribution flag is set to ON. The control section 101 makes such a determination. If no such cards are found, processing is terminated. In connection with the cards for which the distribution flag is set to OFF, delivery of the cards has already been determined. Hence, even when a scheduled delivery date has come, a delivery schedule notification mail in connection with such cards is not sent. The step S70 act as the determination step.

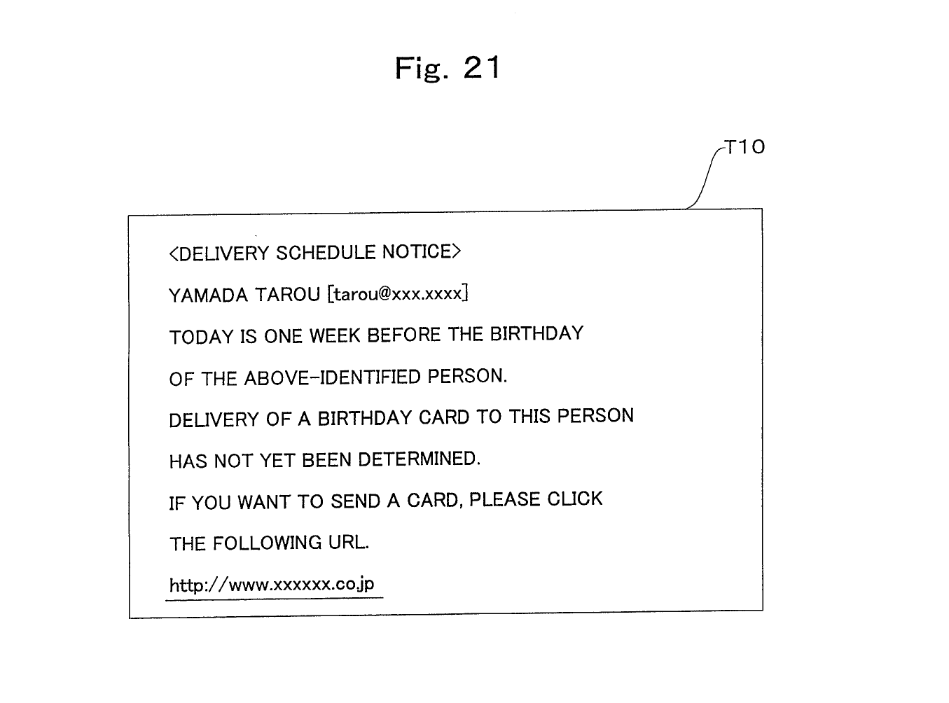

In contrast, when there are cards whose delivery schedule notification dates fall on today and for which the distribution flag is set to ON, that is, the determination in the step S70 is that it is necessary to send the delivery schedule notification mail, a delivery schedule notification mail T10 (FIG. 21) is sent to the distributor user in the form of an E-mail (S71). In connection with cards remaining in a delivery-pending mode, a delivery schedule notification mail is sent to the distributor user.

For instance, when the management table K is in the state shown in FIG. 3, the distribution flag assigned to the birthday card addressed to “NISHIDA Hanako” still remains ON. Since delivery of this birthday card is pending, the delivery schedule notification mail T10 is sent to the E-mail address of the distributor user on September 12, which is the delivery schedule notification date of the birthday card.

The delivery schedule notification mail T10 has contents such as those shown in FIG. 21. The mail informs the distributor user that only a predetermined period is left until a specified delivery date of a reserved card or card which has been delivered in the past. If the distributor user is going to send the card, the mail T10 prompts the distributor user to access a predetermined URL. Data pertaining to a template of a delivery schedule notification mail are stored in the display data storage section 105. Data pertaining to the card are read from the management table K and are pasted onto the template, thus preparing a delivery schedule notification mail. The thus-prepared delivery schedule notification mail is sent to the address of the distributor user.

In a case where a delivery schedule notification mail is sent, the control section 101 and the I/O control section 102 operate in accordance with a program stored in the program storage section 103. At this time, the control section 101, the I/O control section 102, and the program storage section 103 act as a stored data alteration device. Further, step S71 corresponds to a query step.

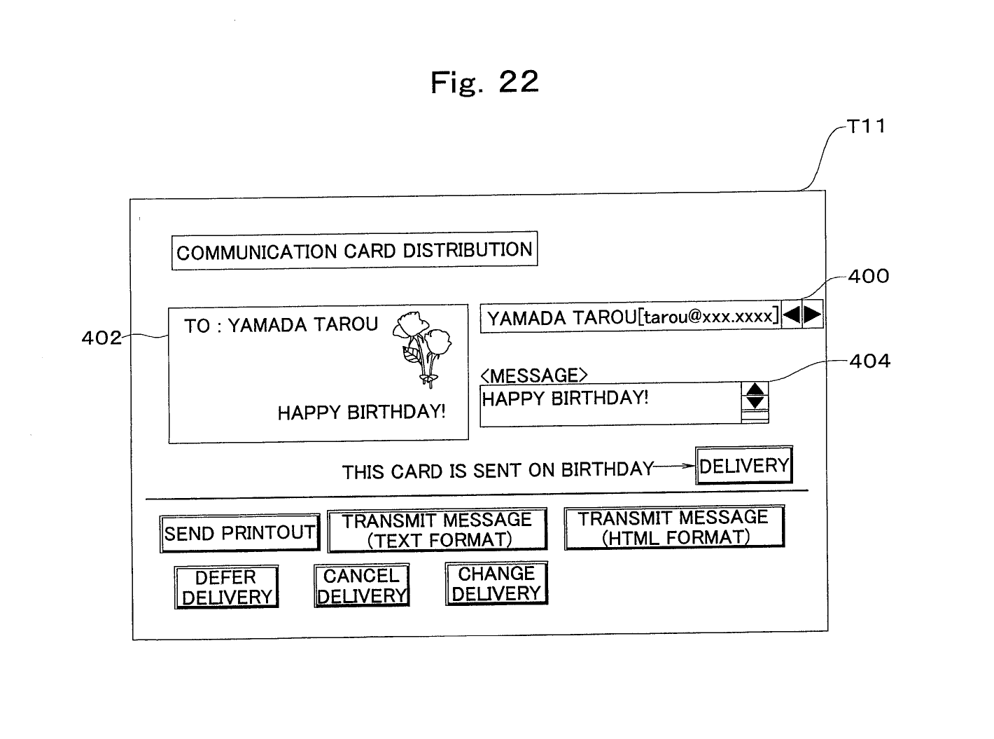

A determination is made as to whether or not a predetermined operation for accessing the predetermined URL has been performed (S72). If it have been determined that the predetermined operation have been performed, a simplified delivery instruction screen T11 (FIG. 22) appears on the user computer of the distributor user. The simplified delivery instruction screen T11 has the function of prompting the distributor user to determine whether to send cards which have not yet been determined to be sent, as well as the function of changing the contents of data pertaining to the card. In connection with processing pertaining to step S72, after the delivery schedule notification mail has been received, a line may be disconnected. Subsequently, the user may again directly access the URL. The same also applies to processing pertaining to step S102.

The simplified delivery instruction screen T11 is provided with a click button “DELIVERY” as well as with click buttons “DEFER DELIVERY,” “CANCEL DELIVERY,” and “CHANGE DELIVER.” Further, the simplified delivery instruction screen Tl1 is provided with click buttons “DELIVER PRINTOUT,” “TRANSMIT MESSAGE (TEXT FORM),” and “TRANSMIT MESSAGE (HTML FORM),” thereby enabling the distributor user to change a delivery mode. In connection with the delivery mode, a click button assigned to the stored mode is highlighted.

The simplified delivery instruction screen T11 is provided with a destination display/input field 400. The name and E-mail address of a destination user stored in connection with the card appear in the destination display/input field 400. In a printout mode, a postal address preferably appears, or both a postal and E-mail addresses may appear. Further, the simplified delivery instruction screen T11 is provided with a card image display field 402, and the image of the stored card appears in the card image display field 402. The simplified delivery instruction screen T11 is further provided with a message display/input field 404, and the stored message appears in the message display/input field 404. The name and E-mail (or postal) address of the destination user, the card image, and the message are displayed on the simplified delivery instruction screen in accordance with the data stored in the management table K.

The name and E-mail address of a destination user can be entered into the destination display/input field 400. If the distributor user desires to change the name or E-mail address of a destination user, the distributor user can make a change to the name or E-mail address, by means of entering required data into the destination display/input field 400. In the case of the printout mode, changes can be made to the destination display/input field 400 by means of entering a “postal address” or both “postal and E-mail addresses.” When a change to the printout mode is made, at least a postal mail address must be entered into the destination display/input field 400. In this case, so long as “CHANGE DELIVERY” is clicked after the “PRINTOUT DELIVERY” click button has been clicked, entry of a postal mail address can be made on the destination input screen T5.

Further, a message can be input to the message display/input field 404. If a change to the message is desired, a new message can be entered into the message display/input field 404, thus changing the message. If the message has been changed, the image of the card in which a revised message has been entered is preferably displayed. In connection with a delivery mode, if a change in delivery mode is desired, the distributor user is required to click only a desired delivery mode. Information about the modification is delivered to the server computer 1 and is temporarily stored in the temporary storage section 107. If no changes are desired, there is no necessity for entering data into the respective input fields and no necessity for clicking any one of the click buttons pertaining to a delivery mode.

Preferably, explanations about how to perform input operations are displayed on the simplified delivery instruction screen T11. Particularly, displaying a statement about delivery (transmission) modes assigned respective click buttons on the simplified instruction screen T11 or displaying functions of the click buttons “DELIVERY,” “DEFER DELIVERY,” “CANCEL DELIVERY,” and “CHANGE DELIVERY” is desirable.

When the distributor user has checked the contents of the data appearing on the simplified delivery instruction screen T11, any one of the click buttons “DELIVERY,” “DEFER DELIVERY,” “CANCEL DELIVERY,” and “CHANGE DELIVERY” is selectively clicked. When the card is to be delivered on a specified delivery date, “DELIVERY” is selected. When the transmission-pending mode is desired to continue, “DEFER DELIVERY” is to be selected. When the card is not to be delivered, “CANCEL DELIVERY” is selected. If the contents of the registered data are desired to be changed, “CHANGE DELIVERY” is to be selected.

A determination is made as to which one of buttons “DELIVERY,” DEFER DELIVERY,” “CANCEL DELIVERY,” and “CHANGE DELIVERY” has been selected, and the following processing operations are performed in accordance with the result of selection.

More specifically, a determination is made as to whether or not “DELIVERY” has been selected (S74). If it have been determined that “DELIVERY” have been selected, the data stored in the management table K are rewritten on the basis of the changes, and the distribution flag is set to OFF (S75). For instance, in a case where changes to the message have been made, the corresponding data stored in the management table K are replaced with the altered message. Further, the distribution flag is set to OFF, whereby the card is delivered on the specified delivery date.

When “DELIVERY” is determined to have not been selected, a determination is made as to whether or not “DEFER DELIVERY” has been selected (S76). When it have been determined that “DEFER DELIVERY” have been selected, the corresponding data stored in the management table K are not replaced with the altered message. Particularly, the distribution flag of the card remains ON. As a result, “RESERVATION” is maintained, and the card is not delivered on a specified delivery date in the near future. A delivery schedule notification mail will again be delivered a predetermined period before the specified date immediately after the next delivery date. The data stored in the management table K may be rewritten on the basis of the changes which have been made on the simplified deliver instruction screen T11.

When “DEFER DELIVERY” is determined to have not been selected, a determination is made as to whether or not “CANCEL DELIVERY” has been selected (S77). When it have been determined that “CANCEL DELIVERY” have been selected, the data pertaining to the card are deleted from the data stored in the management table K (S78). More specifically, the data pertaining to the card stored in the destination user information retained in the management table K are deleted. After erasure of the data, processing may return to an initial screen (FIG. 12).

When it have been determined that “CANCEL DELIVERY” have not been selected, a determination is made as to whether or not “CHANGE DELIVERY” has been selected (S79). When it have been determined that “CHANGE DELIVERY” have been selected, the individual card selection screen T3 (FIG. 14) appears on the user computer (S80). An operation to be performed in step S80 is identical with that to be performed in step S42. When the distributor user desires to change the card image, the user selects a different card image on the individual card selection screen T3. If there is no necessity for changing the card image, only the button “GO TO” is to be clicked.

A determination is made as to whether or not an operation for clicking at least the click button “GO TO” has been performed (S81). If it have been determined that the operation have been performed, the message input screen T4 (FIG. 15) appears on the user computer 2 (S82). Simultaneously, the information newly selectively entered on the individual card selection screen T3 is delivered to the server computer 1, and the data are temporarily stored in the temporary storage section 107.

An operation to be performed in step S82 is identical with that to be performed in step S44. When the distributor user desires to change the message, the user enters a different message on the message input screen T4. If there is no necessity for changing the message, only the button “GO TO” is to be clicked.

A determination is made as to whether or not an operation for clicking at least the click button “GO TO” has been performed (S83). If it have been determined that the operation have been performed, the destination input screen T5 (FIG. 16) appears on the user computer 2 (S84). Simultaneously, the information newly entered on the message input screen T4 is delivered to the server computer 1, and the data are temporarily stored in the temporary storage section 107.

An operation to be performed in step S84 is identical with that to be performed in step S46. When the distributor user desires to change the name or E-mail (or postal) address of the destination, the delivery mode, or the specified delivery date, the user enters new data. If there is no necessity for changing them, only the button “GO TO” is to be clicked.

A determination is made as to whether or not an operation for clicking at least the click button “GO TO” has been performed (S85). If it have been determined that the operation have been performed, the delivery instruction screen T6 (FIG. 17) appears on the user computer 2 (S86). Simultaneously, the information newly entered on the destination input screen T5 is delivered to the server computer 1, and the data are temporarily stored in the temporary storage section 107.

An operation to be performed in step S86 is identical with that to be performed in step S48. Data pertaining to altered items are displayed on the delivery instruction screen T6. if the card can be sent without modifications, the distributor user clicks the button “DELIVERY.” If the user desires to hold delivery of the card, the user clicks the button “RESERVATION.” If the user desires to again attempt to prepare a card from the beginning, the user clicks the “RETRY” button.

The individual card selection screen T3 (step S80), the message input screen T4 (step S82), the destination input screen T5 (step S84), and the delivery instruction screen T6 (step S86) act as correction input screens. When the data pertaining to the individual card selection screen T3 through the delivery instruction screen T6 are delivered to the user computer 2, the control section 101 and the I/O control section 102 operate in accordance with the program stored in the program storage section 103. At this time, the control section 101, the I/O control section 102, and the program storage section 103 act as a correction input screen data transmission device. In connection with steps S80, S82, S84, and S86, a step for transmitting data pertaining to respective screens to the user computer corresponds to a correction input screen data transmission step.

In accordance with the result of selection of a button from among the “DELIVERY,” “RESERVATION,” and “RETRY” buttons, the following processing operations are performed.

On the delivery instruction screen T6, a determination is made as to whether or not “DELIVERY” has been selected (S87). If it have been determined that “DELIVERY” have been selected, the data stored in the management table K are rewritten on the basis of the information retained in the temporary storage section 107 thus far, and the distribution flag is set to OFF (S88). More specifically, the data stored in the management table K are rewritten to the data entered on at least any one of the individual card selection screen T3, the message input screen T4, the destination input screen T5, and the delivery instruction screen T6. An operation to be performed in step S88 is identical with that to be performed in step S50. As the distribution flag is switched to OFF, a card is delivered on the next specified delivery date. After processing pertaining to step S88 has been completed, processing is terminated.

When the data stored in the management table K are changed, the control section 101 operates in accordance with the program stored in the program storage section 103. At this time, the control section 101 and the program storage section 103 act as a stored data change device. Further, step S88 corresponds to a stored data change step.

When it has been determined in step S87 that “DELIVERY” has not been selected, a determination is made as to whether or not “RESERVATION” has been selected (S89). If it have been determined that “RESERVATION” have been selected, the data stored in the management table K are rewritten on the basis of the information retained in the temporary storage section 107, and the distribution flag is set to ON (S90). An operation to be performed in step S90 is identical with that to be performed in step S54.

If it has been determined in step S89 that “RESERVATION” is determined to have not been selected, a determination is made as to whether “RETRY” has been selected (S91). When it have been determined that “RETRY” have been selected, processing returns to step S80, where the individual card selection screen T3 is displayed. If “RETRY” has been selected, the data stored in the management table K are not rewritten on the basis of the data retained in the temporary storage section 107.

The delivery schedule notification mail is delivered not only when “RESERVATION” has been made, but also at a time before the next specified delivery date after the card has already been delivered. For instance, in the case of the birthday card addressed to “NISHIDA Hanako” shown in FIG. 3, if “DELIVERY” has been selected when the delivery schedule notification mail has been sent, the card is to be sent on September 12, which is a specified delivery date. However, the distribution flag of the card is set to ON. Hence, a delivery schedule notification mail is again sent on a delivery schedule notification day before the specified delivery date the next year. Even when “DEFER DELIVERY” is selected in response to a first delivery schedule notification mail that has been sent, the distribution flag still remains ON. Even in this case, a delivery schedule notification mail will be sent on a delivery schedule notification date before the specified delivery date the next year.

As mentioned above, the server computer 1 according to the present embodiment enables the distributor user to ascertain whether to send a card, by means of sending a delivery schedule notification mail before the specified delivery date of the card. Thus, the distributor user is given many opportunities to determine whether to send the card. In connection with the card which has been sent in the past, the card can be used for the next time, by means of a simple operation for changing required data without involvement of entry of all data sets. For instance, when a birthday card is sent to a certain destination user, if the contents of a card to be sent this time can be identical with those of the card sent last time (e.g., last year), the distributor user is required to click only the button “DELIVERY” on the simplified delivery instruction screen T11, thus rewriting the distribution flag of the card. By means of a delivery schedule notification mail, the distributor user can ascertain that the event of the destination user; e.g., a birthday, is coming soon, thereby causing the distributor user to remember delivery of the card.

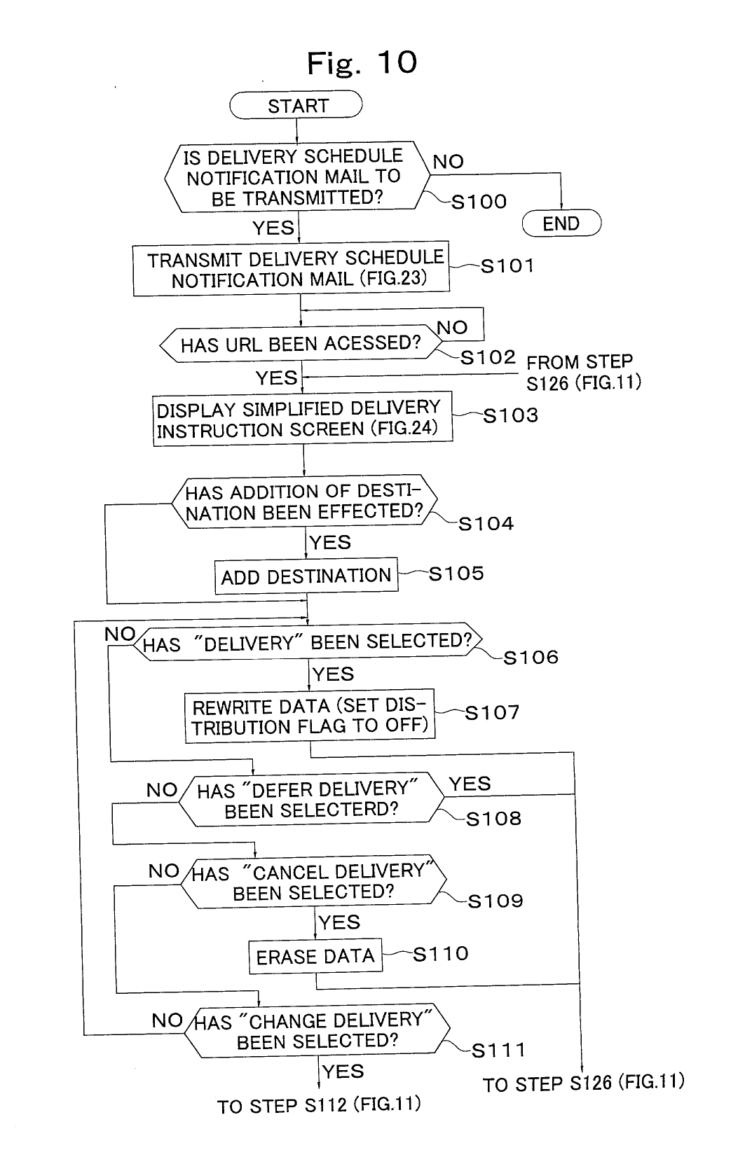

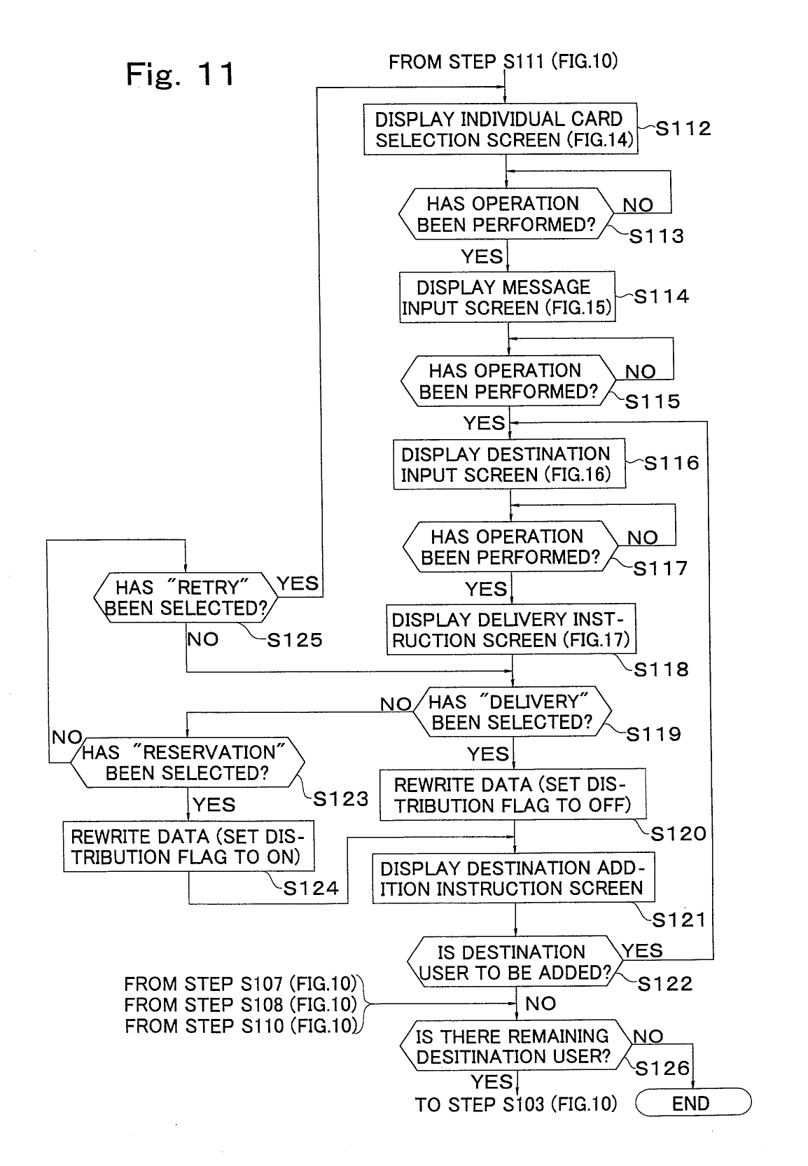

In connection with certain types of cards, such as Christmas cards, New Year's cards, or Valentine cards, which are specified to be delivered on the same day to several destination users, delivery of a delivery schedule notification mail will be described by reference to FIGS. 10 and 11. An operation for delivering a delivery schedule notification mail required in this case is substantially identical with the previously-described case where a delivery schedule notification is sent for a birthday card or a wedding card. However, there is a slight difference.

In connection with a card for a personal anniversary, such as a birthday card or a wedding card, only one delivery notification schedule mail is sent unless an overlap otherwise exists between personal anniversaries of destination users. In contrast, in connection with a card to be sent on a defined day, such as a New Year's Card, delivery schedule notification mails concerning a plurality of New Year's cards are sent to the distributor users on the same day. In such a case, sending a single delivery schedule notification mail is more convenient for the distributor user than is sending delivery schedule notification mails for respective cards, with the result that the distributor user can collectively check and correct the mails by means of a single delivery schedule notification mail.

First, at a predetermined time every day, a determination is made as to whether or not transmission of a delivery schedule notification mail is required (S100). There is made a determination as to whether or not cards whose delivery schedule notification dates fall on today (i.e., a day on which a determination is made) include cards for which the distribution flag is set to ON. In other words, a determination is made in the management able K as to whether or not cards whose delivery schedule notification dates fall on today include cards for which the distribution flag is set to ON. The control section 101 makes such a determination. If no such cards are found, processing is terminated. In connection with the cards for which the distribution flag is set to OFF, delivery of the cards has already been determined. Hence, even when a scheduled delivery date has come, a delivery schedule notification mail in connection with such cards is not sent. The step S100 act as the determination step.

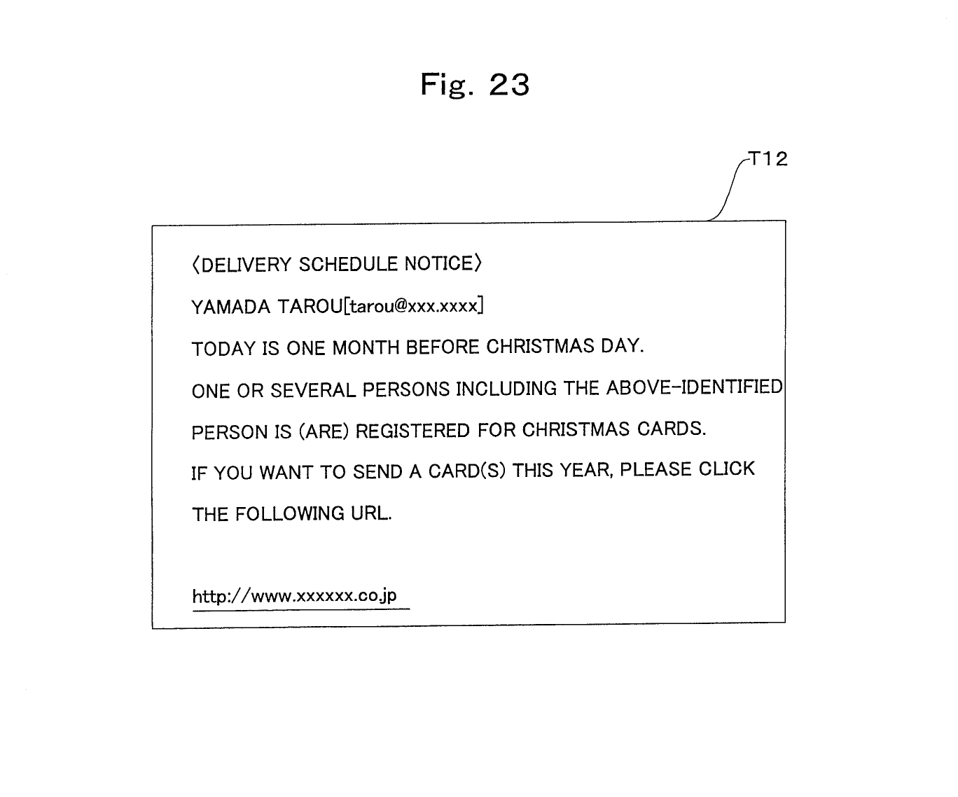

In contrast, when there are cards whose delivery schedule notification dates fall on today and for which the distribution flag is set to ON, that is, the determination in the step S100 is that it is necessary to send the delivery schedule notification mail, a delivery schedule notification mail T12 (FIG. 23) is sent to the distributor user(s) (S101). For instance, when the management table K is in the state shown in FIG. 3, the distribution flag assigned to each of the Christmas cards addressed to “YAMADA Taro” and “NISHIDA Hanako” remains ON. Since delivery of these birthday cards is pending, the delivery schedule notification mail T12 is sent to the E-mail address of the distributor user on December 11, which is a delivery schedule notification date of the Christmas card.

The delivery schedule notification mail T12 has contents such as those shown in FIG. 23. The mail informs the distributor user that only a predetermined period is left until a specified delivery date of a reserved card or a specified delivery date of a card which has been sent in the past., The mail T12 prompts the distributor user to access a predetermined URL if the distributor user is going to send the Christmas cards. The delivery schedule notification mail T12 is an example of a delivery schedule notification mail to be sent for Christmas cards. Delivery schedule notification mails to be sent for events other than Christmas are the same as the delivery schedule notification mail T12.

The delivery schedule notification mail T12 is to be sent not only for cards reserved for delivery but also for cards which have been sent or reserved for delivery at the time of the event of the last year (i.e., Christmas last year).

In a case where a delivery schedule notification mail is sent, the control section 101 and the I/O control section 102 operate in accordance with a program stored in the program storage section 103. At this time, the control section 101, the I/O control section 102, and the program storage section 103 act as a query device. Further, step S101 corresponds to a query step.

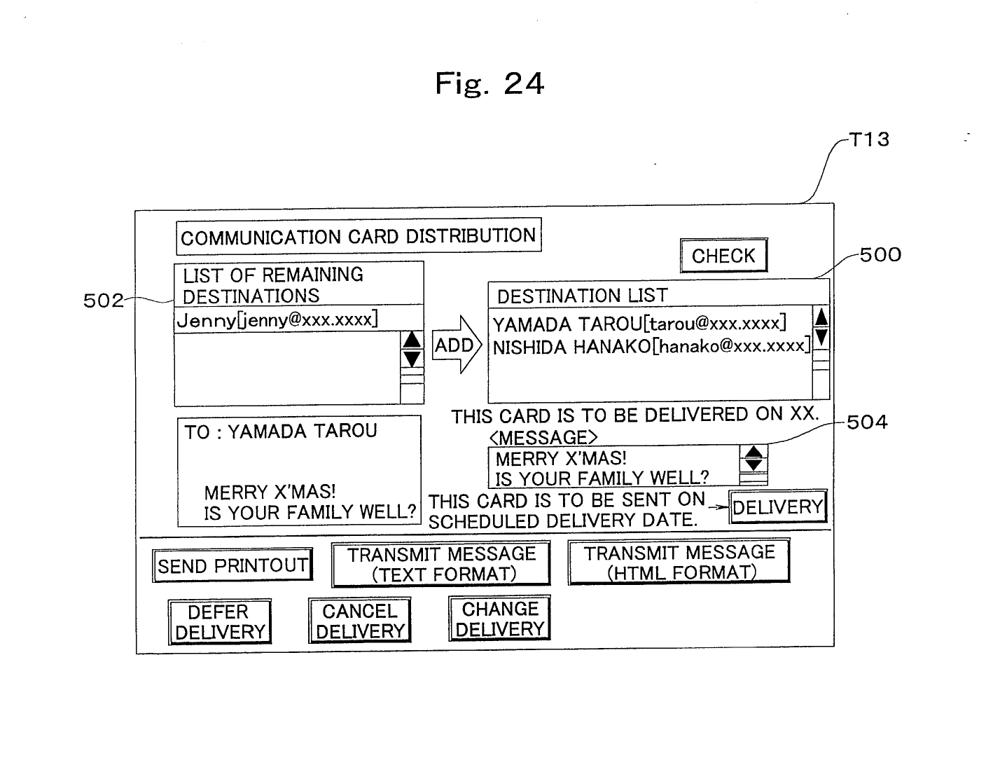

A determination is made as to whether or not a predetermined operation for accessing the predetermined URL has been performed (S102). If it have been determined that the predetermined operation have been performed, a simplified delivery instruction screen T13 (FIG. 24) appears on the user computer of the distributor user. The simplified delivery instruction screen T13 has the function of prompting the distributor user to determine whether to send cards which have not yet been determined to be sent, as well as the function of changing the contents of data pertaining to the cards.

As in the case of the simplified delivery instruction screen T11, the simplified delivery instruction screen T13 is provided with a click button “DELIVERY” as well as with click buttons “DEFER DELIVERY,” “CANCEL DELIVERY,” and “CHANGE DELIVER.” Further, the simplified delivery instruction screen T11 is provided with click buttons “DELIVER PRINTOUT,” “TRANSMIT MESSAGE (TEXT FORM),” and “TRANSMIT MESSAGE (HTML FORM),” thereby enabling the distributor user to change a delivery mode. In a stage before transmission of a delivery schedule notification mail, allowance is made for the possibility of delivery modes of Christmas cards differing according to destination users. Use of the delivery mode change function enables the distributor user to collectively change the delivery modes of the cards to be sent to the specified destination users.

The simplified delivery instruction screen T13 is provided with a destination display/input field 500. The names and E-mail (or postal mail) addresses of the destination users, which have been stored in the distributor user management information in the management table K in association with the type of card corresponding to the delivery schedule notification mail T12, appear in the destination display/input field 500. The card to be displayed is a card for which the distribution flag is set to ON. More specifically, the control section 101 retrieves a card from the management table K, and the name and E-mail (or postal mail) address of the destination assigned the card is displayed. For example, in connection with the management table K shown in FIG. 3, in the case of Christmas cards, the name and E-mail address of “YAMADA Taro” and the name and E-mail address of “NISHIDA Hanako” are displayed. In the printout mode, the postal mail address is preferably displayed in the destination display/input field 500 in the printout mode and the postal mail address and E-mail address may be displayed in the destination display/input field 500 in the printout mode.

Further, the simplified delivery instruction screen T13 is provided with a remaining destination display field 502. In connection with the distributor user management information in the management table K, the name and E-mail address of a destination user which are not displayed in the destination display/input field 500 are displayed in the remaining destination display field 502. Here, in the case of the printout mode, a postal mail address is preferably displayed in the remaining destination display field 502. Alternatively, both a postal mail address and an E-mail address may be displayed. More specifically, the control section 101 retrieves, from the management table K, a remaining destination user which is not displayed in the destination display/input field 500. The name and E-mail address and/or the postal address of the thus-retrieved destination user are displayed in the remaining destination display field 502. In the case of the management table K shown in FIG. 3, if a Christmas card is set as a delivery schedule notification mail, a Christmas card for Jenny is not registered. Hence, the name and E-mail address of “Jenny” are displayed. Although only “Jenny” is displayed in the remaining destination display field 502 shown in FIG. 24, naturally a plurality of destination users are to be displayed if there are a plurality of destination users for which Christmas cards are not registered.

The card image which has already been registered in the management table K appears on the simplified delivery instruction screen T13. If a plurality of destination users are displayed in the destination display/input field 500, the image of the card assigned to one of the destination users (e.g., the top destination user in the destination display/input field 500) is displayed. In the example shown in FIG. 24, the image of a card assigned to “YAMADA Taro” is displayed.

As the image of a card to displayed on the simplified delivery instruction screen T13, a card which is recommended that year may be displayed. A recommended message is displayed along with the image of this recommended card, and at least one of the destination users displayed in the destination display/input field 500 is displayed in the recommended card image.

As the distributor user selects one from the destination users shown in the destination display/input field 500 and clicks the click button “CHECK,” the image of the card assigned to the destination user can be displayed. Thus, the distributor user can ascertain the image of the card assigned to the destination user.

Further, data pertaining to the destination user shown in the remaining destination display field 502 can be added to the destination display/input field 500. As the distributor user clicks a click button “ADDITION” 504 after having selected the destination user shown in the remaining destination display field 502 by means of clicking, the thus-selected destination user is added to the destination display/input field 500. As a result, if “Jenny” is desired to be added the destination display/input field 500 in the example shown in FIG. 24, “Jenny” shown in the remaining destination display field 502 is selected, and the “ADDITION” button is clicked. As a result, data pertaining to “Jenny” are newly added to the destination display/input field 500. Data may be written directly into the destination display/input field 500, whereby the data are added to the destination display/input field 500.

With regard to a message, the simplified delivery instruction screen T13 is provided with a message display/input field 504. The message written in the displayed card image appears in the message display/input field 504. A message can be written into the message display/input field 504. If the distributor user desires to change a message, the distributor user can make a change to a message, by means of entering changes into the message display/input field 504. If changes have been entered into the message display/input field 504, the image of the card in which an altered message is written is preferably displayed.

In connection with a delivery mode, the delivery mode stored in association with the displayed card is highlighted. In the case of a “password” mode, none of the click buttons “DELIVER PRINTOUT,” “TRANSMIT MESSAGE (TEXT FORM),” and “TRANSMIT MESSAGE (HTML FORM)” is highlighted.

For example, in the screen T13 shown in FIG. 24, “YAMADA Taro” is on the top of the list of destination users shown in the destination display/input field 500. In the first stage, the image of the card addressed to “YAMADA Taro” is displayed. “PASSWORD MODE” is registered as a delivery mode for the card addressed to “YAMADA Taro.” Hence, the click button assigned to a delivery mode is not highlighted. For example, if “NISHIDA Hanako” is selected and the click button “CHECK” is clicked, the image of the card addressed to “NISHIDA Hanako” is displayed. Moreover, the click button “DELIVER PRINTOUT” is highlighted.

Preferably, explanations about how to perform input operations are displayed on the simplified delivery instruction screen T13. Particularly, displaying a statement about delivery modes assigned respective click buttons on the simplified instruction screen T13 or displaying functions of the click buttons “DELIVERY,” “DEFER DELIVERY,” “CANCEL DELIVERY,” and “CHANGE DELIVERY” is desirable.

If the registered card may be delivered in its present form, the only requirement is that the distributor user click the click button “DELIVERY.”

If another destination user is desired to be added, an adding operation is performed in the manner as mentioned above. If an operation for adding a new destination user has been performed, the destination user is added to the destination display/input field 500 (S104 and S105).

If changes to the destination users shown in the destination display/input field 500 are desired, the destination users desired to be changed are selected. In this case, a single destination user or a plurality of destination users may be selected. If a plurality of destination users have been selected, the data pertaining to the plurality of destination users stored in the management table K are changed by a single operation. In a case where messages are to be changed, after selection of the destination users for which changes are to be made, changes are input to the message display/input field 504. If images of the cards are desired to be changed, the distributor user clicks the button “CHANGE DELIVERY.”

When the name or E-mail address appearing in the destination display/input field 500 is changed, a change can be made by means of entering a change into the destination display/input field 500. Here, in the case of the printout mode, a “postal mail address” or both “postal and E-mail addresses” are display, thereby enabling changes to the postal mail address and/or E-mail address. When a name and an E-mail address have been changed on the destination display/input field 500 (in the case of the printout mode, either a “postal mail address” or an “E-mail address” has been changed), data pertaining to a destination user may be directly changed. Alternatively, new destination user information may be added to the data pertaining to the destination user.

If a change to delivery mode is desired, the only requirement is that the distributor user click a button assigned to a desired delivery mode. Here, when a change is made to the “printout mode,” a “postal mail address” or “postal and E-mail addresses” are entered on the destination display/input field 500. In this case, so long as the “CHANGE DELIVER” is clicked after the click button “DELIVER PRINTOUT” has been clicked, a postal mail address can be input on the destination input screen T5.

The data altered by means of operation on the simplified delivery instruction screen T13 are sent to the server computer 1, where the data are stored in the temporary storage section 107.

After having checked the contents of the data appearing on the simplified delivery instruction screen T13, any one of the click buttons “DELIVERY,” “DEFER DELIVERY,” “CANCEL DELIVERY,” and “CHANGE DELIVERY” is selectively clicked. Alternatively, before clicking any one of these buttons, the distributor user can select a portion of the destination users shown in the destination display/input field 500. If a portion of the plurality of destination users shown in the destination display/input field 500 have already been selected, processing pertaining to only the thus-selected destination users is performed. Processing pertaining to the remaining destination users is performed by means of subsequent operations. When none of the destination users have been selected, all the destination users shown in the destination display/input field 500 may be deemed as having been selected.

Here, the simplified instruction screen T13 acts as a “selection input screen for enabling selection of at least one from a plurality of cards which are objects of query.” Further, when the data pertaining to the simplified delivery instruction screen T13 are delivered to the user computer 2, the control section 101 and the I/O control section 102 operate in accordance with the program stored in the program storage section 103. At this time, the control section 101, the I/O control section 102, and the program storage section 103 act as a selection input screen data transmission device. In connection with step S103, a step for transmitting data pertaining to the simplified delivery instruction screen T13 to the user computer corresponds to a correction input screen data transmission step.

In accordance with the result of selection of a button from the “DELIVERY,” “DEFER DELIVERY,” “CANCEL DELIVERY,” and “CHANGE DELIVERY” buttons, the following processing operations are performed.

In short, a determination is made as to whether or not “DELIVERY” has been selected. If it have been determined that “DELIVERY” have been selected, the data stored in the management table K are rewritten on the basis of any changes that have been made, and the distribution flag is set to OFF (S107). For example, if a message has been changed, corresponding data stored in the management table K are rewritten on the basis of the thus-altered message. When a portion of the destination users have already been selected from the destination display/input field 500, the data which correspond to the thus-selected destination users and are stored in the management table K are altered.

When a plurality of destination users have been selected and altered, the changes are made to the plurality of destination users by a single operation.

If new destination users are added to the destination display/input field 500, data pertaining to the cards to be sent to the new destination users are added to the management table K. In connection with the thus newly-added destination users, data pertaining to the card identical with that shown on the simplified destination instructions screen T13 are stored in the management table K.

For example, when the management table K is in the state shown in FIG. 3, and when “DELIVERY” has been selected by means of performing an operation for adding “Jenny” to the destination users on the simplified delivery instruction screen T13, data pertaining to a Christmas card are added to Jenny's field in the management table K. While the card addressed to “YAMADA Taro” is displayed on the screen, a card identical with that addressed to “YAMADA Taro” is added to the Jenny's field.

In connection with the example shown in FIG. 24, assuming that “YAMADA Taro,” “NISHIDA Hanako,” and “Jenny” are displayed in the destination display field as a result of addition of “Jenny,” the followings will arise.

In other words, when “DELIVERY” is selected after “YAMADA Taro,” “NISHIDA Hanako,” and “Jenny” have been simultaneously selected by means of dragging operation while the card addressed to “YAMADA Taro” appearing on the screen, a Christmas card identical with that addressed to “YAMADA Taro” is stored in the management table K as a Christmas card for “Jenny.” Similarly, the Christmas card addressed to “NISHIDA Hanako” is rewritten so as to become identical with the Christmas card addressed to “YAMADA Taro.”

In contrast, when “DELIVERY” is selected after “NISHIDA Hanako” and “Jenny” have been selected while the card addressed to “NISHIDA Hanako” is displayed, a Christmas card identical with that addressed to “NISHIDA Hanako” is stored in the management table K as a Christmas card for Jenny. When “DELIVERY” is selected after “NISHIDA Hanako” and “Jenny” have been selected while the card addressed to “YAMADA Taro” is displayed, a Christmas card identical with that addressed to “YAMADA Taro” is stored in the management table K as a Christmas card for Jenny. Similarly, the Christmas card addressed to “NISHIDA Hanako” is rewritten so as to become identical with the Christmas card addressed to “YAMADA Taro.”

By means of selection of “DELIVERY,” the distribution flag is set to OFF. Hence, the cards are to be delivered on a specified delivery date.

If “DELIVERY” is determined to have not been selected, a determination is made as to whether or not “DEFER DELIVERY” has been selected (S108). When it have been determined that “DEFER DELIVERY” have been selected, the data stored in the management table K remain unchanged. Particularly, the distribution flag remains ON. As a result, the cards are not delivered on a specified delivery date in the near future. A delivery schedule notification mail will again be delivered a predetermined period before the specified date immediately after the next delivery date. For example, in the case of New Year's cards addressed to destination users who are in mourning, a delivery schedule notification mail is sent to the distributor user the next year, by means of setting “DEFER DELIVER” to individual destination users. Corresponding data stored in the management table K may be rewritten on the basis of the items which have been changed on the simplified delivery instruction screen T13.

When “DEFER DELIVERY” is determined to have not been selected, a determination is made as to whether or not “CANCEL DELIVERY” has been selected (S109). When it have been determined that “CANCEL DELIVERY” have been selected, the data pertaining to the selected cards are deleted from the data stored in the management table K (S110). More specifically, the data pertaining to the cards stored in the destination user information retained in the management table K are deleted.

When “CANCEL DELIVERY” is determined to have not been selected, a determination is made as to whether or not “CHANGE DELIVERY” has been selected (S111). When it have been determined that “CHANGE DELIVERY” have been selected, the individual card selection screen T3 appears on the user computer (S112). An operation to be performed in step S112 is identical with that to be performed in step S80. In this case, the immediately-preceding card which has been appearing on the simplified delivery instruction screen T13 is highlighted on the individual card selection screen T3. When the distributor user desires to change the card, the only requirement is that he select another card image on the simplified delivery instruction screen T13. If no changes to the card are necessary, only the button “GO TO” is to be clicked.

A determination is made as to whether or not an operation for clicking at least the click button “GO TO” has been performed (S113). If it have been determined that the operation have been performed, the message input screen T4 (FIG. 15) appears on the user computer 2 (S114). Simultaneously, the information newly selectively entered on the individual card selection screen T3 is delivered to the server computer 1, and the data are temporarily stored in the temporary storage section 107.

An operation to be performed in step S114 is identical with that to be performed in step S82. In this case, the message of the immediately-preceding card which has been appearing on the simplified delivery instruction screen T13 appears on the message input screen T4. When the distributor user desires to change the message, the user enters a different message on the message input screen T4. If there is no necessity for changing the message, only the button “GO TO” is to be clicked.

A determination is made as to whether or not an operation for clicking at least the click button “GO TO” has been performed (S115). If it have been determined that the operation have been performed, the destination input screen T5 appears on the user computer 2 (S116). Simultaneously, the information newly entered on the message input screen T4 is delivered to the server computer 1, and the data are temporarily stored in the temporary storage section 107.

An operation to be performed in step S116 is identical with that to be performed in step S84. The screen analogous to the destination input screen T5 (FIG. 16) appears on the user computer 2. As a predetermined button is clicked on the destination input screen T5, the names and E-mail (or postal) addresses of the destination users selected in the destination display/input field 500 are sequentially displayed, thereby enabling alteration of the name or E-mail (or postal) address of each of the destination users. At this time, the destination modes of the cards addressed to these destination users may be changed individually. When the distributor user changes the name, E-mail (or postal) address, or delivery mode of the destination user, the distributor user is required to enter only changes. If no changes are required, only the button “GO TO” is to be clicked. In the printout delivery mode, a postal address is displayed in the destination display/input field 500 in place of the E-mail address, thereby enabling changing of the postal address. Since the specified delivery date is determined and unchangeable.

A determination is made as to whether or not an operation for clicking at least the click button “GO TO” has been performed (S117). If it have been determined that the operation have been performed, the delivery instruction screen T6 (FIG. 17) appears on the user computer 2 (S118). Simultaneously, the information newly entered on the destination input screen T5 is delivered to the server computer 1, and the data are temporarily stored in the temporary storage section 107.

An operation to be performed in step S118 is identical with that to be performed in step S86. Data pertaining to altered items are displayed on the delivery instruction screen T6. If the card can be sent without modifications, the distributor user clicks the button “DELIVERY.” If the user desires to hold delivery of the card, the user clicks the button “RESERVATION.” If the user desires to again attempt to prepare a card from the beginning, the user clicks the “RETRY” button.

The individual card selection screen T3 (step S112), the message input screen T4 (step S114), the destination input screen T5 (step S116), and the delivery instruction screen T6 (step S118) act as correction input screens. When the data pertaining to the individual card selection screen T3 through the delivery instruction screen T6 are delivered to the user computer 2, the control section 101 and the I/O control section 102 operate in accordance with the program stored in the program storage section 103. At this time, the control section 101, the I/O control section 102, and the program storage section 103 act as a correction input screen data transmission device. In connection with steps S112, S114, S116, and S118, a step for transmitting data pertaining to respective screens to the user computer corresponds to a correction input screen data transmission step.

In accordance with the result of selection of a button from among the “DELIVERY,” “RESERVATION,” and “RETRY” buttons, the following processing operations are performed.

On the delivery instruction screen T6, a determination is made as to whether or not “DELIVERY” has been selected (S119). If it have been determined that “DELIVERY” have been selected, the data stored in the management table K are rewritten on the basis of the information retained in the temporary storage section 107 thus far, and the distribution flag is set to OFF (S120). An operation to be performed in step S120 is identical with that to be performed in step S88. When a plurality of destination users have been selected from the destination display/input field 500, corresponding portions of the data pertaining to the destination users are rewritten on the basis of the changes made in steps S112 through S118, by means of a single operation. Further, the distribution flags of the cards addressed to these destination users are set to OFF. Hence, the cards are to be sent on the next specified delivery dates.

When the data stored in the management table K are changed, the control section 101 operates in accordance with the program stored in the program storage section 103. At this time, the control section 101 and the program storage section 103 act as a stored data change device. Further, step S120 corresponds to a stored data change step.

After step S120, the destination addition instruction screen (T7) is displayed (S121). The destination addition instruction screen T7 is provided with click buttons “SEND” and “DO NOT SEND”. When a destination user is added, “SEND” is to be clicked. In contrast, when a destination user is not added, “DO NOT SEND” is to be clicked.

A determination is made as to whether either “SEND” or “DO NOT SEND” has been selected(S122). When it have been determined that “SEND” have been selected, processing returns to step S116. In contrast, when “DO NOT SEND” is determined to have been selected, processing proceeds to step S126. A determination is made as to whether or not destination users which have not been selected from the destination display/input field 500 of the simplified delivery instruction screen T13 still remain. If unselected destination users still remain, processing returns to step S103, and the simplified delivery instruction screen T13 is displayed. At this time, the data pertaining to the destination users for which processing has already been completed are deleted from the destination display/input field 500.

When it has been determined in step S119 that “DELIVERY” has not been selected, a determination is made as to whether or not “RESERVATION” has been selected (S123). If it have been determined that “RESERVATION” have been selected, the data stored in the management table K are rewritten on the basis of the information retained in the temporary storage section 107, and the distribution flag is set to ON (S124). When a plurality of destination users have been selected from the destination display/input field 500, corresponding portions of the data pertaining to the destination users are rewritten on the basis of the changes made in steps S112 through S118, by means of a single operation. An operation to be performed in step S124 is identical with that to be performed in step S90.

If it has been determined in step S123 that “RESERVATION” has not been selected, a determination is made as to whether “RETRY” has been selected (S125). When it have been determined that “RETRY” have been selected, processing returns to step S112, where the individual card selection screen T3 is displayed. If “RETRY” has been selected, the data stored in the management table K are not rewritten on the basis of the data retained in the temporary storage section 107.

As mentioned above, the server computer 1 according to the present embodiment enables a card which has been sent or reserved in the past to be used the next time without involvement of reentry of all data sets, by means of sending a delivery schedule notification mail in connection with the card, and by means of changing only required data. Particularly, delivery of a delivery schedule notification mail to the plurality of destination users can be effected by means of a single operation. Therefore, the operation can be facilitated considerably. Particularly, if a card identical with that sent last time can be sent to a plurality of destination users, the distributor user is required to click only the “DELIVERY” button on the simplified delivery instruction screen T13, thereby rewriting the distribution flags assigned to the destination users.

In connection with the description concerning “(2) Changes in card delivery history information,” a plurality of cards which are to be delivered on the same date, such as Christmas cards or New Year's cards, may be selected collectively in step S41. Details of the thus-selected cards may be changed by a single operation. In this case, operations pertaining to steps S42 through S50 become identical with those pertaining to steps S112 and S120. Further, operations pertaining to steps S53 and S54 become identical with those pertaining to steps S123 and S124.

Although the above embodiments have described cards, such as Birthday cards, Wedding cards, New Year's cards, Christmas cards, and Valentine cards, the present invention is not limited to these types of cards. The present invention can be applied to other types of greeting cards. Further, the present invention can be also applied to cards except for greeting cards.

As for “E-mail address” in above explanation, the present invention is not limited to “E-mail address”. Another address except for E-mail address can be applicable to the present invention. For example, the data which can specify the address electrically can be applicable to the present invention.

The present invention may be embodied as follows:

Specifically, the present invention provides a server computer which delivers cards in accordance with data entered by way of a user computer, comprising a control device and a storage device. The storage device preserves a card delivery history and the input data pertaining to the cards described in the delivery history. The control device displays, on the user computer, a selection input screen which enables selection of desired cards from the card delivery history stored in the storage device. On the user computer, there is displayed a correction input screen for enabling correction of data pertaining to the cards selected on the selection input screen and/or entry of new data for the selected cards. The data pertaining to the selected cards stored in the storage device are rewritten on the basis of the corrected and/or newly-entered data.

Preferably, when a plurality of cards are selected from the delivery history, the data pertaining to the plurality of cards stored in the storage device are rewritten on the basis of the corrected and/or newly-entered data, by means of a single operation.

Further, the present invention may be embodied as follows:

Specifically, the present invention provides a server computer which delivers cards in accordance with data entered by way of a user computer, comprising a control device and a storage device. The storage device preserves a card delivery history and the input data pertaining to the cards described in the delivery history. When a delivery schedule notification date has come, the control device sends to the user computer a query message as to whether to send the card, the date being determined by subtracting a predetermined period from a specified delivery date of the card.

Preferably, the control device displays, on the user computer, a correction input screen which enables correction and/or new entry of data pertaining to the card for which the delivery schedule notification date has come. Further, the data pertaining to the card stored in the storage device are preferably rewritten on the basis of the corrected and/or newly-entered data.

In this case, if there are plurality of cards for which the delivery schedule dates have come, the control device displays, on the user computer, a selection input screen which makes at least one of the cards selectable. Preferably, when a plurality of cards have been selected on the selection input screen, the data pertaining to the plurality of cards stored in the storage device are rewritten on the basis of the corrected and/or newly-entered data, by means of a single operation.

So long as data can be displayed on the user computer, a selection input screen data transmission device may be replaced with a selection input screen display device. Similarly, a correction input screen data transmission device may be replaced with a correction input screen display. Further, an application input screen data transmission device may be replaced with an application input screen display device. So long as data can be displayed on the user computer, a selection input screen data transmission step may be replaced with a selection input screen display step. Similarly, a correction input screen data transmission step may be replaced with a correction input screen display step. An application input screen data transmission step may be replaced with an application input screen display step.

The present invention may also be embodied as follows:

Specifically, the present invention provides a card distribution control method comprising the steps of:

displaying, on a user computer, a selection input screen which enables selection of desired cards from a card delivery history stored in a storage device;

displaying, on the user computer, a correction input screen for enabling correction of data pertaining to the cards selected on the selection input screen and/or entry of new data for the selected cards; and

rewriting data pertaining to the selected cards stored in the storage device, on the basis of the corrected and/or newly-entered data.

Preferably, when a plurality of cards are selected from the delivery history, the data pertaining to the plurality of cards stored in the storage device are rewritten on the basis of the corrected and/or newly-entered data, by means of a single operation.

Further, the present invention may also be embodied as follows:

Specifically, the present invention provides a card distribution control method, wherein a query message as to whether to send a card is sent to a user computer when a delivery schedule notification date has come, which date is determined by subtracting a predetermined period from a specified delivery date of the card.

Preferably, the method comprises a step of displaying, on the user computer, a correction input screen which enables correction and/or new entry of data pertaining to the card for which the delivery schedule notification date has come, and a step of rewriting the data pertaining to the card stored in the storage device, on the basis of the corrected and/or newly-entered data.

In this case, if there are plurality of cards for which the delivery schedule dates have come, there is displayed, on the user computer, a selection input screen which makes at least one of the cards selectable. Further, when a plurality of cards have been selected on the selection input screen, the data pertaining to the plurality of cards stored in the storage device are preferably rewritten on the basis of the corrected and/or newly-entered data, by means of a single operation.

Processing pertaining to the steps of the card delivery control method may be implemented in the form of a program to be executed by a computer, a recording medium having the program recorded thereon, or a carrier wave having the program superimposed thereon.

1. A server computer which performs an operation for sending cards to destinations in accordance with operation of a user computer, comprising:
a storage device for storing, on a per-card basis, data which are required for sending a card to a predetermined destination, at least a portion of the data being based on data received from the user computer;
a selection input screen data transmission device which sends data pertaining to the selection input screen to the user computer for causing the user computer to display a selection input screen, wherein the selection input screen displays on a per-card basis a predetermined data set of the data stored in the storage device and enables selection of at least one card;
a correction input screen data transmission device which transmits data pertaining to a correction input screen to the user computer in order to cause the user computer to display the correction input screen, the correction input screen being a single or a plurality of input screens for enabling, on the user computer, at least one of a data correction operation for correcting data pertaining to cards selected on the selection input screen and a data addition operation for effecting addition of data pertaining to the selected card; and
a stored data change device which makes at least changes or additions to the data which pertain to a selected card and are stored in the storage device, on the basis of data received from the user computer in accordance with an input operation performed on the correction input screen.

2. The server computer according to claim 1, wherein there can be performed, on the correction input screen, a card addition operation for enabling addition of data pertaining to a new card, through use of data pertaining to a card selected on the selection input screen, and the stored data change device adds data pertaining to a new card to the data stored in the storage device when the card addition operation has been performed on the correction input screen.

3. The server computer according to claim 1, further comprising an application input screen data transmission device which transmits data pertaining to the application input screen to the user computer in order to cause the user computer to display an application input screen, the application input screen being a single or a plurality of input screens for enabling, on the user computer, an operation for sending a card to a desired destination; and wherein at least a portion of the data stored in the storage device for each card are stored through use of data which have been received from the user computer in accordance with an input operation on the application input screen.

4. The server computer according to claim 1, wherein, when a plurality of cards are selected on the selection input screen and when there is performed, on the correction input screen, at least one of an operation for correcting data pertaining to the selected plurality of cards and an operation for effecting addition of data pertaining to the selected cards, the stored data change device rewrites the data pertaining to the plurality of cards in accordance with data received as a result of an input operation on the correction input screen, by means of a single operation.

5. The server computer according to claim 1, further comprising a card delivery device for performing procedures for sending a card to a destination on a predetermined delivery date; and wherein the card delivery device has a plurality of modes which are selectable in a card delivery mode by a distribution user; at least one of a plurality of modes is a principal mode for sending, to a user computer of a destination user, data for specifying a site for browsing a card and data which are required for browsing a card and are uniquely provided to the destination user; and at least one of the other modes is a mail mode for sending at least a message in the form of an electronic mail, or a printout mode for printing a card and sending the printed card to a destination user.

6. The server computer according to claim 3, wherein at least one of the application input screen and the correction input screen enables selection of one from a delivery-determined mode for sending a card on a predetermined delivery date, and a delivery-pending mode for holding delivery of a card even when a predetermined delivery date has come, and data pertaining to either the delivery-determined mode or the delivery-pending mode are stored for each card in the storage device.

7. The server computer according to claim 6, wherein an indication stating that either the delivery-determined mode or the delivery-pending mode is assigned to a card is displayed for each card on the selection input screen.

8. A server computer which performs an operation for sending cards to destinations in accordance with operation of a user computer, comprising:
a storage device for storing, on a per-card basis, data which are required for sending a card to a predetermined destination, at least a portion of the data being based on data received from the user computer; and
a query device which sends, to the user computer, a message querying whether to perform an operation for sending a card on a predetermined delivery date, with regard to a predetermined card of cards stored in the storage device.

9. The server computer according to claim 8, wherein the storage device stores at least data pertaining to a card-delivery date, as well as either a delivery-determined mode for sending a card on a delivery date or a delivery-pending mode for holding delivery of a card even when a delivery date has come, with regard to whether to send a card; and the query device makes a query in connection with a card remaining in a delivery-pending mode.

10. The server computer according to claim 8, wherein the query device sends the message on a date which is determined by subtracting a predetermined period from the delivery date.

11. The server computer according to claim 8, further comprising:
a correction input screen data transmission device which transmits data pertaining to a correction input screen to the user computer in order to cause the user computer to display the correction input screen, the correction input screen being one or a plurality of input screens for effecting, on the user computer, at least one operation of a data correction operation for correcting data pertaining to cards for which queries have been made by the query device, and a data addition operation for effecting addition of data pertaining to the cards; and
a stored data change device which makes at least changes or additions to the data which pertain to a selected card and are stored in the storage device, on the basis of data received from the user computer in accordance with an input operation performed on the correction input screen.

12. The server computer according to claim 11, wherein there can be performed, on the correction input screen, a card addition operation for enabling addition of data pertaining to a new card, through use of data pertaining to the cards for which queries have been made by the query device, and the stored data change device adds data pertaining to a new card to the data stored in the storage device when the card addition operation has been performed on the correction input screen.

13. The server computer according to claim 11, wherein, when a plurality of cards of the same type are objects of query, the query device makes a query concerning the plurality of cards by means of a single operation; and wherein the server computer further comprises a selection input screen data transmission device which transmits to the user computer data pertaining to a selection input screen, in order to cause the user computer to display the selection input screen for enabling selection of at least one card from the plurality of cards which are objects of query, wherein on the correction input screen there can be performed at least either a data correction operation for correcting data pertaining to cards selected on the selection input screen, or a data addition operation for effecting addition of data pertaining to the selected card.

14. The server computer according to claim 13, wherein, when a plurality of cards are selected on the selection input screen and when there is performed, on the correction input screen, at least either an operation for correcting data pertaining to the selected plurality of cards or an operation for effecting addition of data pertaining to the selected cards, the stored data change device rewrites the data pertaining to the plurality of cards in accordance with data received from the user computer as a result of an input operation on the correction input screen, by means of a single operation.

15. A card delivery control method in which a server computer is used for performing an operation for sending cards to destinations in accordance with operation of a user computer, comprising:
a selection input screen data transmission step which sends data pertaining to the selection input screen to the user computer for causing the user computer to display a selection input screen, wherein the selection input screen displays on a per-card basis a predetermined data belonging to the data stored in a storage device and enables selection of at least one card, wherein the storage device stores, on a per-card basis, data required for sending a card to a predetermined destination, a portion of the data being based on data received from a user computer;
a correction input screen data transmission step of transmitting to the user computer data pertaining to a correction input screen in order to cause the user computer to display the correction input screen, the correction input screen being a single or a plurality of input screens for enabling, on the user computer, at least either a data correction operation for correcting data pertaining to cards selected on the selection input screen or a data addition operation for effecting addition of data pertaining to the selected card; and
a stored data change step which makes at least changes or additions to the data which pertain to a selected card and are stored in the storage device, on the basis of data received from the user computer in accordance with an input operation performed on the correction input screen.

16. The card delivery control method according to claim 15, wherein there can be performed, on the correction input screen, a card addition operation for enabling addition of data pertaining to a new card through use of data pertaining to a card selected on the selection input screen, and the stored data change step involves addition of data pertaining to a new card to the data stored in the storage device when the card addition operation has been performed on the correction input screen.

17. The card delivery control method according to claim 15, further comprising an application input screen data transmission step of sending data pertaining to the application input screen to the user computer in order to cause the user computer to display an application input screen, the application input screen being a single or a plurality of input screens for enabling, on the user computer, an operation for sending a card to a desired destination; and wherein at least a portion of the data stored in the storage device for each card are stored through use of data which have been received from the user computer in accordance with an input operation on the application input screen.

18. The card delivery control method according to claim 15, wherein, when a plurality of cards are selected on the selection input screen and when there is performed, on the correction input screen, at least either an operation for correcting data pertaining to the selected plurality of cards or an operation for effecting addition of data pertaining to the selected cards, the stored data change step involves rewriting of the data pertaining to the plurality of cards in accordance with data received as a result of an input operation on the correction input screen, by means of a single operation.

19. The card delivery control method according to claim 15, further comprising a card delivery step of executing procedures for sending a card to a destination on a predetermined delivery date; the card delivery step is provided with a plurality of modes which can be selected in a card delivery mode by a distributor user; at least one of the plurality of modes is a principal mode for sending, to a user computer of a destination user, data for specifying a site for browsing a card and data which are required for browsing the card and uniquely provided to the destination user; and at least one of the other modes is a mail mode for sending to a destination user at least a message in the form of an electronic mail, or a printout mode for printing a card and sending the printed card to the destination user.

20. The server computer according to claim 17, wherein at least either the application input screen or the correction input screen enables selection of one from a delivery-determined mode for sending a card on a predetermined delivery date, and a delivery-pending mode for holding delivery of a card even when a predetermined delivery date has come, and data pertaining to either the delivery-determined mode or the delivery-pending mode are stored for each card in the storage device.

21. The server computer according to claim 20, wherein an indication stating that either the delivery-determined mode or the delivery-pending mode is assigned to a card is displayed for each card on the selection input screen.

22. A card delivery control method in which a server computer is used for performing an operation for sending cards to destinations in accordance with operation of a user computer, comprising:
a query step of sending, to the user computer, a message querying whether to perform an operation for sending a card on a predetermined delivery date, with regard to a predetermined card of cards stored in a storage device which stores on a per-card basis data required for sending a card to a predetermined destination, at least a portion of the data being based on data received from the user computer.

23. The card delivery control method according to claim 19, wherein the storage device stores at least data pertaining to a card-delivery date and either a delivery-determined mode for sending a card on a delivery date, or a delivery-pending mode for holding delivery of a card even when a delivery date has come, with regard to whether to send a card; and the query steps involves issuance of a query in connection with a card remaining in a delivery-pending mode.

24. The card delivery control method according to claim 22, wherein the query step is effected on a date which is determined by subtracting a predetermined period from the delivery date.

25. The card delivery control method according to claim 22, further comprising:
a correction input screen data transmission step of transmitting to the user computer data pertaining to a correction input screen in order to cause the user computer to display the correction input screen, the correction input screen being one or a plurality of input screens for effecting, on the user computer, at least either a data correction operation for correcting data pertaining to cards for which queries have been made by the query step, or a data addition operation for effecting addition of data pertaining to the cards; and
a stored data change step of making at least changes or additions to the data which pertain to a selected card and are stored in the storage device, on the basis of data received from the user computer in accordance with an input operation performed on the correction input screen.

26. The card delivery control method according to claim 25, wherein there can be performed, on the correction input screen, a card addition operation for enabling addition of data pertaining to a new card through use of data pertaining to the cards for which queries have been made in the query step, and the stored data change step effects addition of data pertaining to a new card to the data stored in the storage device when the card addition operation has been performed on the correction input screen.

27. The card delivery control method according to claim 25, wherein, when a plurality of cards of the same type are objects of query, in the query step a query about the plurality of cards is made by means of a single operation; and wherein the card delivery control method further comprises a selection input screen data transmission step of transmitting to the user computer data pertaining to a selection input screen, in order to cause the user computer to display the selection input screen for enabling selection of at least one card from the plurality of cards which are objects of query, wherein on the correction input screen there can be performed at least either a data correction operation for correcting data pertaining to cards selected on the selection input screen, or a data addition operation for effecting addition of data pertaining to the selected card.

28. The card delivery control method according to claim 27, wherein, when a plurality of cards are selected on the selection input screen and when there is performed, on the correction input screen, either an operation for correcting data pertaining to the selected plurality of cards or an operation for effecting addition of data pertaining to the selected cards, the stored data change step effects rewriting of the data pertaining to the plurality of cards in accordance with data received from the user computer as a result of an input operation on the correction input screen, by means of a single operation.
